(19) United States
(12) Patent Application Publication
(10) Pub. No.: US 2025/0181205 A1
(43) Pub. Date: Jun. 5, 2025

(54) ELECTRONIC DEVICE AND METHOD FOR GROUPING MULTIPLE WIDGETS IN ELECTRONIC DEVICE

(71) Applicant: Samsung Electronics Co., Ltd., Suwon-si (KR)

(72) Inventors: Gisoo LEE, Suwon-si (KR); Sangheon KIM, Suwon-si (KR); Dongjun LEE, Suwon-si (KR); Myungjun KWAK, Suwon-si (KR); Junkyu PARK, Suwon-si (KR); Youngseung SEO, Suwon-si (KR); Yeunwook LIM, Suwon-si (KR)

(21) Appl. No.: 19/047,129

(22) Filed: Feb. 6, 2025

Related U.S. Application Data
(63) Continuation of application No. PCT/KR2023/010611, filed on Jul. 21, 2023.

(30) Foreign Application Priority Data
Aug. 8, 2022 (KR) 10-2022-0098801
Oct. 13, 2022 (KR) 10-2022-0131116

(51) Int. Cl. G06F 3/0481; G06F 3/0484; G06F 9/451

(52) U.S. Cl. CPC G06F 3/0481; G06F 3/0484; G06F 9/451

(57) ABSTRACT

An electronic device is provided. The electronic device includes a display, memory storing one or more computer programs, and one or more processors communicatively coupled to the display and the memory, wherein the one or more computer programs include computer-executable instructions that, when executed by the one or more processors individually or collectively, cause the electronic device to, when identifying movement of a widget displayed on the display to a widget group, identify whether there is a size that is smaller than or equal to a first size corresponding to a size of the widget group from among at least one size supported by the widget, in case that there is a size smaller than or equal to the first size of the widget group among the at least one size supported by the widget, change the widget to the size smaller than or equal to the first size of the widget group, move the resized widget to the widget group, and display the resized widget to overlap the widget group.

### CROSS-REFERENCE TO RELATED APPLICATION(S)

This application is a continuation application, claiming priority under 35 U.S.C. § 365(c), of an International application No. PCT/KR2023/010611, filed on Jul. 21, 2023, which is based on and claims the benefit of a Korean patent application number 10-2022-0098801, filed on Aug. 8, 2022, in the Korean Intellectual Property Office, and of a Korean patent application number 10-2022-0131116, filed on Oct. 13, 2022, in the Korean Intellectual Property Office, the disclosure of each of which is incorporated by reference herein in its entirety.

### BACKGROUND

### 1. Field

The disclosure relates to an electronic device and a method for grouping multiple widgets in an electronic device.

### 2. Description of Related Art

Electronic devices provide widgets that gather frequently used functions so that users may use them right away on the home screen.

The widgets are a collection of service tools that gather various functions such as memos, weather, calendars, schedule management, clocks, and notices into a predetermined area of the home screen, thereby enabling the users to view them right away, and the users may also select and use only the functions they need from among the various functions.

A plurality of widgets on the home screen of the electronic device may be respectively displayed, or may be displayed such that widgets with the same size overlap each other.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for grouping multiple widgets in an electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory storing one or more computer programs, and one or more processors communicatively coupled to the display and the memory, wherein the one or more computer programs include computer-executable instructions that, when executed by the one or more processors individually or collectively, cause the electronic device to, when identifying movement of a widget displayed on the display to a widget group, identify whether there is a size smaller than or equal to a first size corresponding to a size of the widget group among at least one size supported by the widget, and in case that there is a size smaller than or equal to the first size of the widget group among the at least one size supported by the widget, change the widget to the size smaller than or equal to the first size of the widget group, move the resized widget to the widget group, and display the resized widget to overlap the widget group.

In accordance with another aspect of the disclosure, a method performed by an electronic device for grouping a plurality of widgets is provided. The method includes based on identifying movement of a widget displayed on a display of the electronic device to a widget group, identifying, by the electronic device, whether there is a size smaller than or equal to a first size corresponding to a size of the widget group among at least one size supported by the widget, and based on identifying that there is the size smaller than or equal to the first size of the widget group among the at least one size supported by the widget, changing, by the electronic device, the widget to the size smaller than or equal to the first size of the widget group, moving, by the electronic device, the resized widget to the widget group, and displaying, by the electronic device, the resized widget to overlap the widget group.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device according to an embodiment of the disclosure;

FIG. 3 is a diagram illustrating various types of electronic devices capable of grouping a plurality of widgets according to an embodiment of the disclosure;

FIG. 4A is a diagram illustrating a grid configuring a display in an electronic device according to an embodiment of the disclosure;

FIG. 4B is a diagram illustrating a grid configuring a display in an electronic device according to an embodiment of the disclosure;

FIG. 4C is a diagram illustrating a grid configuring a display in an electronic device according to an embodiment of the disclosure;

FIG. 5A is a diagram illustrating a type of widget that may be displayed on a display in an electronic device according to an embodiment of the disclosure;

FIG. 5B is a diagram illustrating a type of widget that may be displayed on a display in an electronic device according to an embodiment of the disclosure;

FIG. 6A is a diagram illustrating an operation of displaying a first widget on a display in an electronic device according to an embodiment of the disclosure;

FIG. 6B is a diagram illustrating an operation of displaying a first widget on a display of an electronic device according to an embodiment of the disclosure;

FIG. 6C is a diagram illustrating an operation of displaying a first widget on a display of an electronic device according to an embodiment of the disclosure;

FIG. 6D is a diagram illustrating an operation of displaying a first widget on a display of an electronic device according to an embodiment of the disclosure;

FIG. 6E is a diagram illustrating an operation of displaying a first widget on a display of an electronic device according to an embodiment of the disclosure;

FIG. 7A is a diagram illustrating an operation of displaying a second widget on a display of an electronic device according to an embodiment of the disclosure;

FIG. 7B is a diagram illustrating an operation of displaying a second widget on a display of an electronic device according to an embodiment of the disclosure;

FIG. 8A is a diagram illustrating an operation of overlapping widgets in an electronic device according to an embodiment of the disclosure;

FIG. 8B is a diagram illustrating an operation of overlapping widgets in an electronic device according to an embodiment of the disclosure;

FIG. 9A is a diagram illustrating an operation of overlapping widgets in an electronic device according to an embodiment of the disclosure;

FIG. 9B is a diagram illustrating an operation of overlapping widgets in an electronic device according to an embodiment of the disclosure;

FIG. 10A is a diagram illustrating an operation of overlapping widgets in an electronic device according to an embodiment of the disclosure;

FIG. 10B is a diagram illustrating an operation of overlapping widgets in an electronic device according to an embodiment of the disclosure;

FIG. 11A is a diagram illustrating a widget group in an electronic device according to an embodiment of the disclosure;

FIG. 11B is a diagram illustrating a widget group in an electronic device according to an embodiment of the disclosure;

FIG. 12 is a diagram illustrating an edit mode of a widget in an electronic device according to an embodiment of the disclosure;

FIG. 13A is a diagram illustrating an operation of controlling a widget in a folded state in an electronic device according to an embodiment of the disclosure;

FIG. 13B is a diagram illustrating an operation of controlling a widget in a folded state in an electronic device according to an embodiment of the disclosure;

FIG. 13C is a diagram illustrating an operation of controlling a widget in a folded state in an electronic device according to an embodiment of the disclosure;

FIG. 14 is a diagram illustrating an operation of updating the size of a widget group in an electronic device according to an embodiment of the disclosure;

FIG. 15A is a diagram illustrating an operation of controlling a widget group according to a change in the display size of an electronic device according to an embodiment of the disclosure;

FIG. 15B is a diagram illustrating an operation of controlling a widget group according to a change in the display size of an electronic device according to an embodiment of the disclosure;

FIG. 16A is a diagram illustrating an operation of controlling a widget group according to a change in the display size of an electronic device according to an embodiment of the disclosure;

FIG. 16B is a diagram illustrating an operation of controlling a widget group depending on a change in the display size of an electronic device according to an embodiment of the disclosure;

FIG. 17 is a diagram illustrating an operation of determining a size of a widget group in an electronic device according to an embodiment of the disclosure;

FIG. 18 is a diagram illustrating an operation of determining a size of a widget group in an electronic device according to an embodiment of the disclosure;

FIG. 19 is a diagram illustrating an operation of displaying a widget group in an electronic device according to an embodiment of the disclosure;

FIG. 20A is a diagram illustrating an operation of displaying a widget group in an electronic device according to an embodiment of the disclosure;

FIG. 20B is a diagram illustrating an operation of displaying a widget group in an electronic device according to an embodiment of the disclosure;

FIG. 20C is a diagram illustrating an operation of displaying a widget group in an electronic device according to an embodiment of the disclosure;

FIG. 21A is a diagram illustrating an operation of displaying a widget group in an electronic device according to an embodiment of the disclosure;

FIG. 21B is a diagram illustrating an operation of displaying a widget group in an electronic device according to an embodiment of the disclosure;

FIG. 21C is a diagram illustrating an operation of displaying a widget group in an electronic device according to an embodiment of the disclosure;

FIG. 22 is a flowchart illustrating an operation of grouping a plurality of widgets in an electronic device according to an embodiment of the disclosure; and

FIG. 23 is a flowchart illustrating an operation of controlling a widget group depending on a folded state of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

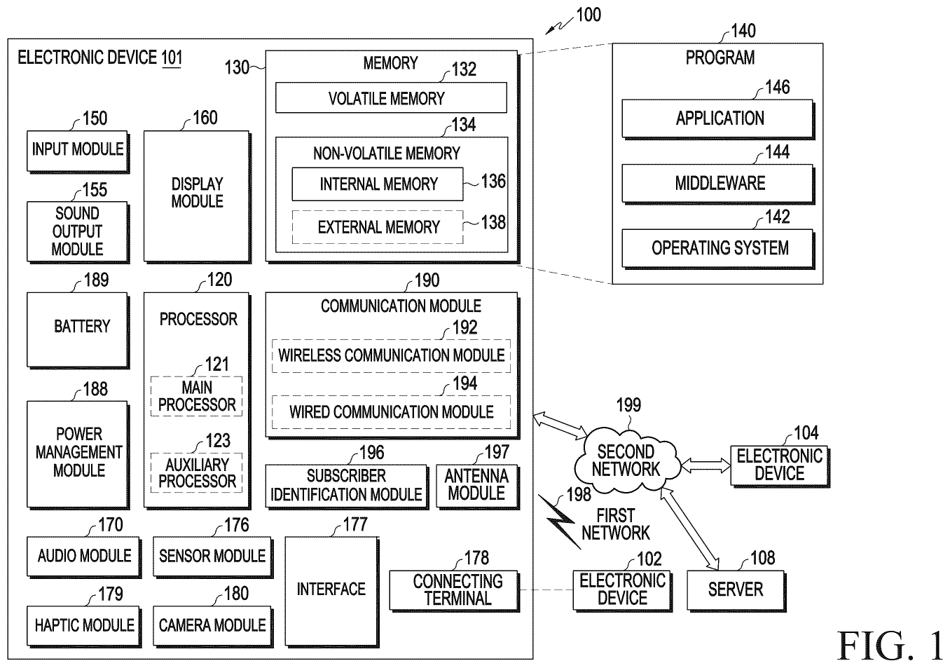

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic device 102 and the electronic device 104 may be a device of a same type as, or a different type, from the electronic device 101. According to an embodiment, all or some of operations to be executed at the electronic device 101 may be executed at one or more of the external electronic devices (e.g., the electronic device 102, the electronic device 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

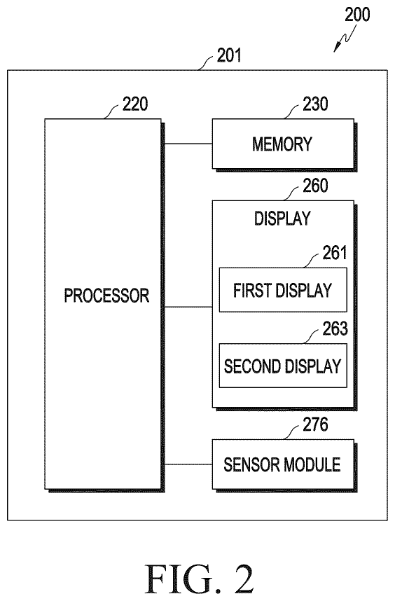

FIG. 2 is a block diagram of an electronic device according to an embodiment of the disclosure.

Referring to FIG. 2, block diagram 200 illustrates that an electronic device 201 may include a processor 220, a display 260 including a first display 261 and a second display 263, memory 230, and a sensor module 276.

According to an embodiment, the processor 220 may change a plurality of widgets having different sizes to the same size, move them to a widget group, and then display them to overlap each other.

According to an embodiment, in the case of identifying movement of a widget displayed on the display 260 to a position where a widget group is disposed, if there is a size that is smaller than or equal to a first size corresponding to the size of the widget group among one or more sizes supported by the widget, the processor 220 may change the size of the widget to the size smaller than or equal to the first size corresponding to the size of the widget group, and may then move the widget to the widget group and display it to overlap the widget group.

According to an embodiment, the processor 220 may display a widget and/or a widget group on a home screen displayed on the display 260. The processor 220 may display at least one home screen (e.g., a desktop screen), configure the home screen with various grids, and display at least one icon and widget corresponding to at least one application on the home screen.

According to an embodiment, if a first gesture (e.g., a long press in which one finger touches for a predetermined period of time or a multi-long press in which at least two fingers touch for a predetermined period of time) on the widget displayed on the display 260 is identified, and if a continuous second gesture (e.g., drag and drop) following the first gesture is identified, the processor 220 may identify the movement of the widget to the position where the widget group is disposed.

According to an embodiment, if the first gesture (e.g., the long press or multi-long press) is identified on the widget, the processor 220 may detect state information of the widget. The processor 220, based on the state information of the widget, may determine whether the widget is a first widget whose size is changeable or a second widget whose size is unchangeable. The processor 220, based on the state information of the widget, may identify a plurality of sizes supported by the first widget and identify the size of the second widget.

According to an embodiment, in the case where the widget displayed on the display 260 is identified as the first widget whose size is changeable, if there is a size that is smaller than or equal to a first size corresponding to the size of the widget group among the plurality of sizes supported by the first widget, the processor 220 may change the size of the first widget to the size smaller than or equal to the first size corresponding to the size of the widget group, and may then move the widget to the widget group and display it to overlap the widget group.

According to an embodiment, in the case where the widget displayed on the display 260 is identified as the first widget whose size is changeable, if the current size of the first widget is identified as a size smaller than or equal to a first size corresponding to the size of the widget group, the processor 220 may move the first widget to the widget group without changing the size of the first widget and display it to overlap the widget group.

According to an embodiment, in the case where the widget displayed on the display 260 is identified as the second widget whose size is unchangeable, if the current size of the second widget is identified as a size smaller than or equal to a first size corresponding to the size of the widget group, the processor 220 may move the second widget to the widget group and display it to overlap the widget group.

According to an embodiment, in the case where the widget displayed on the display 260 is the first widget whose size is changeable, if it is identified that there is no size that is smaller than or equal to the first size of the widget group among the plurality of sizes supported by the first widget, the processor 220 may identify a second size corresponding to the smallest size among the plurality of sizes supported by the first widget. The processor 220 may change the size of the widget group from the first size to the second size, and change the second widget to the second size. The processor 220 may move the second widget having the changed second size to the widget group and display it to overlap the widget group.

According to an embodiment, if it is identified that there is no size that is smaller than or equal to the first size of the widget group among the plurality of sizes supported by the first widget, and if a second size corresponding to the smallest size among the plurality of sizes supported by the first widget, the processor 220 may identify at least one size supported by each of at least one widget included in the widget group. If the at least one widget is changeable to the second size, based on the at least one size supported by the at least one widget, the processor 220 may change the widget group including the at least one widget to the second size. If all or one of the at least one widget is unchangeable to the second size, based on the at least one size supported by the at least one widget, the processor 220 may not perform an operation of moving the widget to the widget group and displaying it to overlap the widget group.

According to an embodiment, in the case where the widget displayed on the display 260 is the second widget whose size is unchangeable, if it is identified that the size of the second widget is not smaller than or equal to the first size of the widget group, the processor 220 may change the size of the widget group from the first size to the size of the second widget and move the second widget to the widget group to be displayed to overlap the widget group.

According to an embodiment, if it is identified that the size of the second widget is not smaller than or equal to the first size of the widget group, the processor 220 may identify at least one size supported by each of at least one widget included in the widget group. Based on the at least one size supported by the at least one widget, if the at least one widget is changeable to the size of the second widget, the processor 220 may change the widget group including the at least one widget to the size of the second widget. Based on the at least one size supported by the at least one widget, if all or one of the at least one widget is unchangeable to the size of the second widget, the processor 220 may not perform an operation of moving the widget to the widget group and displaying it to overlap the widget group.

According to an embodiment, if it is possible to move the widget displayed on the display 260 to the widget group to be displayed to overlap the widget group, the processor 220 may provide a cue notifying that the widget is capable of overlapping the widget group at the time of overlapping.

According to an embodiment, since the plurality of widgets included in the widget group are all stacked while having the same size or a smaller size than other widgets, the processor 220 may display one widget when displaying the widget group on the display 260, and the one widget may include a recently overlapping widget, a widget selected by the user, or a widget that is used a predetermined number of times or more. If a third gesture (e.g., left/right swapping) is detected from the widget group, based on the user's selection, the processor 220 may sequentially display the plurality of widgets included in the widget group in response to the third gesture.

According to an embodiment, when displaying the widget group on the display 260, the processor 220 may display an indicator indicating the number of widgets included in the widget group, while displaying one widget among the plurality of widgets included in the widget group, in a predetermined area of the one widget.

According to an embodiment, when a new widget overlaps the widget group, the processor 220 may display an indicator indicating the number of widgets included in the widget group and release the display of the indicator after a predetermined period of time elapses.

According to an embodiment, when displaying a home screen on which the widget group is displayed, among a plurality of home screens (e.g., when displaying a home screen on which the widget group is displayed by swiping left and right, displaying a home screen on which the widget group is displayed by input to a home key while executing a specific application, or displaying a home screen on which the widget group is displayed after unlocking the electronic device), the processor 220 may display an indicator indicating the number of widgets included in the widget group and release the display of the indicator after a predetermined period of time elapses.

According to an embodiment, when displaying a quick option, based on a first gesture (e.g., long press) detected on the widget group, the processor 220 may display an indicator indicating the number of widgets included in the widget group and release the display of the indicator when the display of the quick option is released.

According to an embodiment, if a second gesture (e.g., drag and drop) for overlapping a new widget on the widget group is detected, the processor 220 may display an indicator indicating the number of widgets for each of all widget groups, where the second gesture occurred, displayed on the home screen and release the indicator when the second gesture ends.

According to an embodiment, if a new widget overlaps the widget group, the processor 220 may display the widget group as the new widget and change the widget, displayed as the widget group before the new widget overlaps the same, to the next of the new widget in sequence.

For example, in the state where the widget group includes “widget A>widget B>widget C>widget D” that sequentially overlap each other, if a new widget E overlaps the widget group, based on a third gesture (e.g., left and right swipe) detected in the widget group, while displaying widget B included in the widget group, the processor 220 may include “widget A>widget B>widget E>widget C>widget D” sequentially overlapping each other in the widget group, and display the newly overlapping widget E as the widget group. The processor 220 may change the indicator indicating the number of widgets included in the widget group according to the new widget E overlapping the widget group and display it in a predetermined area of the widget E.

According to an embodiment, the processor 220 may display a quick option when detecting a first gesture (e.g., long press) on the widget group and enter an edit mode of the widget group, based on selection of an edit button for the widget group provided by the quick option.

According to an embodiment, the processor 220 may detect a second gesture (e.g., drag and drop) for moving a new widget to the widget group to overlap the same, and may display, if the second gesture is released within a predetermined period of time, the new widget overlapping the widget group and, if the second gesture is not released within a predetermined period of time, enter an edit mode of the widget group.

According to an embodiment, in the edit mode of the widget group, the processor 220 may delete at least one widget from among the plurality of widgets included in the widget group through a widget removal function and, if another widget exists on the left or right of the deleted widget, move the widget existing on the left or right to the position of the deleted widget to be displayed therein.

For example, in the edit mode of the widget group, the processor 220 may provide an indicator indicating a widget removal function in each of the plurality of widgets included in the widget group. The processor 220 may delete a widget of which the indicator indicating the widget removal function displayed on the widget is selected while sequentially displaying the plurality of widgets, based on a third gesture (e.g., left and right swipe) detected on the widget group.

According to an embodiment, the processor 220 may change the order of the plurality of widgets included in the widget group through a widget reordering function in the edit mode of the widget group.

For example, the processor 220 may change the order of a widget selected by a long press, among the plurality of widgets included in the widget group, through a long-press and move in the edit mode of the widget group. If the widget where the long press is detected moves beyond a predetermined area, the processor 220 may display the widget on the display 260 without including it in the widget group. If the widget is identified to be a widget whose size has changed while being included in the widget group, the processor 220 may change the widget to the size before the change and display it on the display 260.

According to an embodiment, the processor 220, in the edit mode of the widget group, may add a new widget through a widget addition function and may filter a widget that is changeable to a size smaller than or equal to the size of the widget group (e.g., the first widget whose size is changeable) or a widget that has a size smaller than or equal to the size of the widget group (e.g., the second widget whose size is unchangeable) and provide it to the user. The processor 220 may arrange the widget, which is newly added through the widget addition function, in the last order.

For example, the processor 220, in the edit mode of the widget group, may provide a widget addition button for adding a new widget in the last order while sequentially displaying the plurality of widgets, based on a third gesture (e.g., left and right swipe) detected on the widget group.

According to an embodiment, if the edit mode of the widget group is terminated while sequentially displaying the plurality of widgets, based on a third gesture (e.g., left and right swipe) detected on the widget group, in the edit mode of the widget group, the processor 220 may display a widget selected based on the third gesture (e.g., left and right swipe) as the widget group.

According to an embodiment, the processor 220, in the edit mode of the widget group, may configure activation or deactivation of a function of auto-rotating widgets for moving to the widget corresponding to a currently running application and displaying.

For example, when a music application is running and music is being played on the electronic device 201 in the state where the function of auto-rotating widgets is activated, the processor 220 may perform moving to a music-related widget, among the multiple widgets included in the widget group, and displaying.

According to an embodiment, if the sizes of multiple widgets included in the widget group are changed, the processor 220 may change the size of the widget indicated by the widget group and update the same, and then sequentially change the sizes of the remaining widgets and update them. If the sizes of multiple widgets included in the widget group are changed and updated at the same time, multiple applications respectively corresponding to the multiple widgets must be executed at the same time, and thus, a load may occur on the main thread due to the time required to change the sizes of the multiple widgets at the same time. For example, if the sizes of 10 widgets included in the widget group are changed at the same time, it takes approximately 600 ms, which causes the load on the main thread. Therefore, if the size of the widget indicated by the widget group, among the 10 widgets, is changed and updated first, and then the sizes of the remaining 9 widgets are changed and updated sequentially, the load on the main thread may be distributed, thereby improving the frame drop on the screen.

According to an embodiment, if the processor 220 detects a first folded state (e.g., half-folded state) of the electronic device in which the electronic device is folded at a predetermined angle (e.g., 80 degrees to 130 degrees) while managing a widget group displayed on an external display provided outside a housing of the electronic device 201 and the widget group displayed on the display 260 as a pair, the processor 220 may hide the widget group displayed on the display 260, instead of changing the size of the widget group to display the widget group displayed on the display 260 through the first display 261 or the second display 263 of the display 260, and display the widget group, displayed on the external display, on the first display or the second display of the display 260.

According to an embodiment, while displaying the widget group on the display 260, the processor 220 may change the size of the widget group to correspond to the change in the size of the display and display it. When changing the size of the widget group in response to a change in the size of the display (e.g., expanding and/or contracting in the horizontal direction of the display, or expanding and/or contracting in the vertical direction of the display), the processor 220 may change the size of the widget displayed in the widget group and update the same, and may sequentially change the sizes of the remaining widgets and update the same.

According to an embodiment, when the processor 220 detects a first folded state (e.g., half-folded state) of the electronic device 201 in which the electronic device is folded at a predetermined angle (e.g., 80 degrees to 130 degrees) from an unfolded state, based on a signal received from the sensor module 276, if the display of at least a part of the widget group is identified in an area where the first display 261 and the second display 263 face each other, the processor 220 may move the widget group to the first display 261 or the second display 263 and display it. If the widget group is displayed on the area where the first display 261 and the second display 263 face each other in the first folded state (e.g., half-folded state) of the electronic device, the widget group may be moved to the first display 261 or the second display 263 and displayed thereon, thereby resolving problems regarding readability and user input.

According to an embodiment, in the case where the first display 261 is used as a display unit and the second display 263 is used as an input unit in the first folded state (e.g., half-folded state) of the electronic device, the processor 220 may move the widget group to the second display 263 and display it.

According to an embodiment, when moving the widget group to the second display 263 used as an input unit in the first folded state (e.g., half-folded state) of the electronic device, the processor 220 may determine a plurality of areas having a plurality of coordinates at which the widget group is to be displayed as starting coordinates on the second display 263, and may move and display the widget group to and on a first area having a first coordinate, as a starting coordinate, that is positioned closest to the starting coordinate of the area where the widget group is positioned, among the plurality of areas. If there is an existing icon or widget in the first area, the processor 220 may move and display the widget group to and on a second area having a second coordinate, as a starting coordinate, that is the next closest after the first area to the starting coordinate of the area where the widget group is positioned, among the plurality of areas.

According to an embodiment, when moving the widget group to the second display 263 used as an input unit in the first folded state (e.g., half-folded state) of the electronic device, if there is no space to display the widget group on the second display 263 due to the existing multiple icons or widgets thereon, the processor 220 may move at least one icon or widget, based on a priority, among the multiple icons or widgets displayed on the second display 263, to the first display 261, and then move and display the widget group to and on the second display 263.

According to an embodiment, when moving the widget group to the second display 263 used as an input unit in the first folded state (e.g., half-folded state) of the electronic device, the processor 220 may change the size of the widget group and display it. For example, when moving a widget group having a size of 3×3 to a predetermined area of the second display 263 and displaying it in the first folded state (e.g., half-folded state) of the electronic device, the processor 220 may change the size of the widget group to 4×1 to correspond to the predetermined area of the second display 263.

According to an embodiment, when moving the widget group to the second display 263 used as an input unit in the first folded state (e.g., half-folded state) of the electronic device, the processor 220 may change the size of a grid configuring the home screen of the second display 263 and display the widget group maintaining its size on the home screen of the second display 263 of which the grid was changed.

According to an embodiment, when moving the widget group to the second display 263 used as an input unit in the first folded state (e.g., half-folded state) of the electronic device, if the widget group includes a second widget whose size is unchangeable, the processor 220 may reduce only the scale of the second widget while maintaining the ratio of the second widget and display it.

According to an embodiment, the processor 220, based on a third gesture (e.g., left and right swipe) detected in the widget group that was moved and displayed on the second display 263 in the first folded state (e.g., half-folded state) of the electronic device, may sequentially display the plurality of widgets included in the widget group.

According to an embodiment, based on a third gesture (e.g., left and right swipe) detected in the widget group that was moved and displayed on the second display 263 in the first folded state (e.g., half-folded state) of the electronic device, the processor 220 may sequentially display the plurality of widgets included in the widget group by allowing looping in one direction (e.g., rightward direction).

According to an embodiment, in the case where a plurality of widgets having different sizes (e.g., a plurality of first widgets whose sizes are changeable) overlap each other with their own sizes to produce a widget group, the processor 220 may determine a size corresponding to an intersection of the sizes of the plurality of widgets, change the sizes of the plurality of widgets to the size corresponding to the intersection, and then display the widget group on the display 260.

According to an embodiment, the processor 220 may change the size of the widget (e.g., the first widget whose size is changeable) displayed on the display 260 in a horizontal, vertical, and/or diagonal direction using multi-touch (e.g., pinch zoom) as well as a handler function.

According to an embodiment, the processor 220 may provide a post-it effect through an operation of detaching a widget or widget group displayed on the display 260 and an operation of attaching the detached widget or widget group to another home screen, lock screen, or task bar.

According to an embodiment, when a widget displayed on the display 260 moves to the widget group and overlap the same, the processor 220 may determine an optimal size of the widget so as to be included in the widget group, based on the size of the widget and the sizes of the plurality of widgets included in the widget group, and change the size of the widget and the size of the widget group to the size, and then move the widget to the widget group to be displayed to overlap the same.

According to an embodiment, the processor 220 may change the type of grid configuring the home screen displayed on the display 260, and display the widget group on the home screen configured as the changed grid. For example, since visibility of the widget group may be secured by displaying the widget group on a home screen configured as a 5×5 grid rather than displaying the widget group on a home screen configured as a 6×5 grid, which is the basic grid, the processor 220 may display the widget group on the home screen obtained by changing the basic grid of 6×5 to the 5×5 grid.

According to an embodiment, the processor 220 may display a form (e.g., an icon) representing the widget group in a predetermined area (e.g., 1×1) of the display 260 and, if a touch is detected from the form (e.g., an icon) representing the widget group, the processor 220 may display a plurality of widgets included in the widget group in a pop-up form in the predetermined area where the touch is detected.

According to an embodiment, if the processor 220 detects a first gesture (e.g., a long press) on the widget group displayed on the display 260 when the electronic device 201 is in an unfolded state, and detects folding of the electronic device 201 while detecting the first gesture, the processor 220 may display all of the plurality of widgets included in the widget group in a predetermined area of the display 260, excluding the area where the widget group is displayed. If the processor 220 does not detect the first gesture while displaying the widget group and all of the plurality of widgets included in the widget group on the display 260 when the electronic device 201 is in the folded state, the processor 220 may release the display of the plurality of widgets included in the widget group and display the widget group.

According to an embodiment, the memory 230 (e.g., the memory 130 in FIG. 1) may store state information of a widget that may be provided from the electronic device. The state information may include information indicating whether the widget is a first widget whose size is changeable or a second widget whose size is unchangeable. The state information may include information about a plurality of sizes supported by the first widget or size information of the second widget.

According to an embodiment, the sensor module 276 (e.g., the sensor module 176 in FIG. 1) may include various sensors capable of detecting a first folded state (e.g., half-folded state) in which the electronic device is folded at a predetermined angle (e.g., 80 degrees to 130 degrees) from an unfolded state.

According to an embodiment, the sensor module 276 (e.g., the sensor module 176 in FIG. 1) may include an angle sensor, a tilt sensor, an acceleration sensor, a geomagnetic sensor, a gyro sensor, a motion sensor, a gravity sensor, and a proximity sensor. For example, the sensor module 376 may detect a first folded state (e.g., half-folded state) in which the electronic device is folded at a predetermined angle (e.g., 80 degrees to 130 degrees) from an unfolded state using sensor information received from at least one of the angle sensor, the tilt sensor, the acceleration sensor, the geomagnetic sensor, the gyro sensor, or the motion sensor.

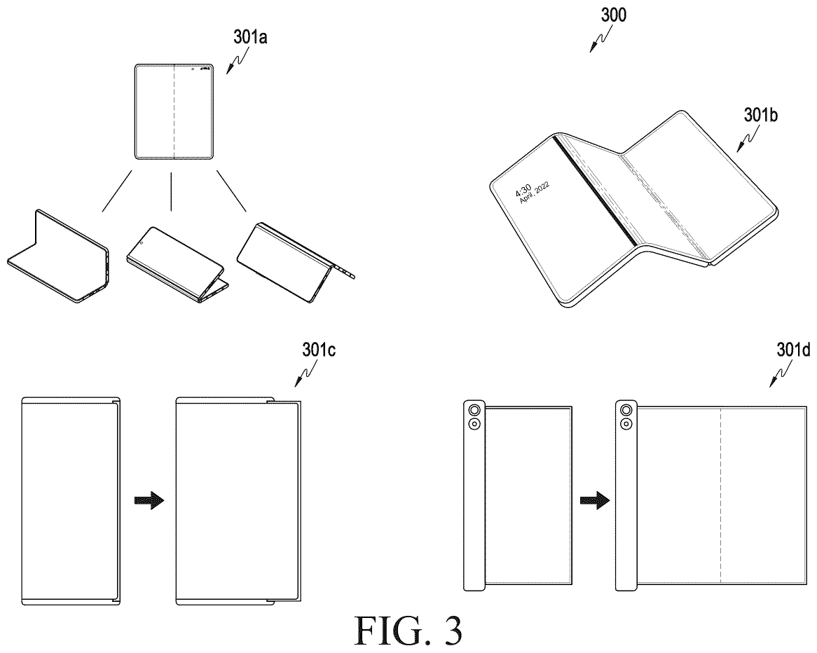

FIG. 3 is a diagram illustrating various types of electronic devices capable of grouping a plurality of widgets according to an embodiment of the disclosure.

Referring to FIG. 3, diagram 300 illustrates that the electronic device capable of grouping a plurality of widgets may include a foldable-type electronic device 301a that is folded based on one hinge axis, a foldable-type electronic device 301b capable of being folded in an in-folding and out-folding manner based on two hinge axes, a slide-type electronic device 301c capable of expanding and contracting a display, and a rollable-type electronic device 301d in which a display is exposed outside and inserted into a housing.

According to the disclosure, the electronic device capable of grouping a plurality of widgets is not limited to the foldable-type electronic devices 301a and 301b, the slide-type electronic device 301c, and the rollable-type electronic device 301d shown in FIG. 3, and may include various electronic devices whose display sizes are unchangeable or changeable.

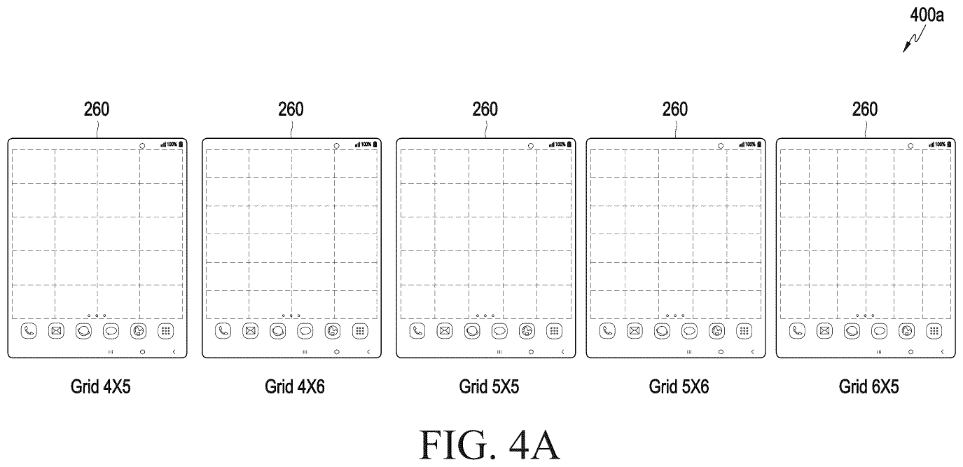

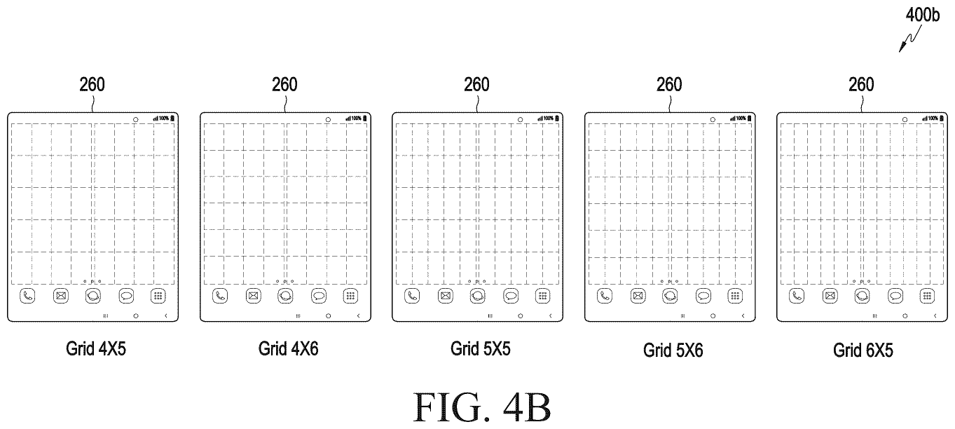

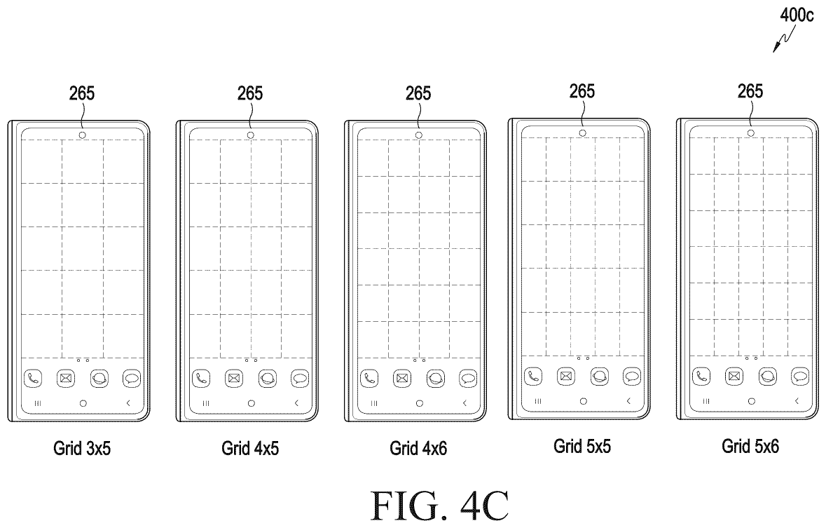

FIGS. 4A to 4C are diagrams illustrating a grid configuring a display in an electronic device according to various embodiments of the disclosure.

Referring to FIG. 4A, diagram 400a illustrates that an electronic device (e.g., the electronic device 101 in FIG. 1, the electronic device 201 in FIG. 2, and/or the electronic devices 301a to 301d in FIG. 3) may configure the home screen as a grid when displaying the home screen on a display 260 (e.g., the display module 160 in FIG. 1 and/or the display 260 in FIG. 2), and, for example, may configure the home screen as one of a 4×5 grid, a 4×6 grid, a 5×5 grid, a 5×6 grid, and a 6×5 grid.

Referring to FIG. 4B, diagram 400b illustrates that an electronic device (e.g., the electronic device 101 in FIG. 1, the electronic device 201 in FIG. 2, and/or the electronic devices 301a to 301d in FIG. 3) may configure the home screen as a grid when displaying the home screen on a display 260 (e.g., the display module 160 in FIG. 1 and/or the display 260 in FIG. 2), and, for example, may configure the home screen as one of a 4×5 mirroring grid, a 4×6 mirroring grid, a 5×5 mirroring grid, a 5×6 mirroring grid, and a 6×5 mirroring grid. For example, if the home screen is configured as a 4×5 mirroring grid, the electronic device may display the settings and layout of the home screen configured in the 4×5 mirroring grid configured in some area (e.g., the left area) of the home screen by mirroring them to another area (e.g., the right area) of the home screen.

Referring to FIG. 4C, diagram 400c illustrates that an electronic device (e.g., the electronic device 101 in FIG. 1, the electronic device 201 in FIG. 2, and/or the electronic devices 301a to 301d in FIG. 3) may configure an external display 265 as a grid, and, for example, may configure the external display 265 as any one of a 3×5 grid, a 4×5 grid, a 4×8 grid, a 5×5 grid, and a 5×6 grid.

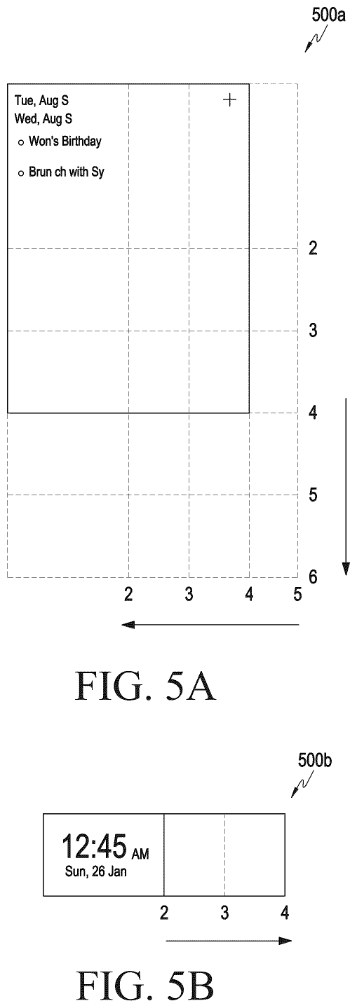

FIGS. 5A and 5B are diagrams illustrating types of widgets that may be displayed on a display of an electronic device according to various embodiments of the disclosure.

Referring to FIG. 5A, diagram 500a illustrates that an electronic device (e.g., the electronic device 101 in FIG. 1, the electronic device 201 in FIG. 2, and/or the electronic devices 301a to 301d in FIG. 3) may provide a collection widget that represents a list view and/or a grid view. The collection widget may include a widget for a calendar list and/or a widget for an email. The collection widget is a first widget whose size is changeable, and may be displayed in a 4×2 size by default, and may support a 2×2 size, a 3×3 size, and a 5×6 size.

Referring to FIG. 5B, diagram 500b illustrates that an electronic device (e.g., the electronic device 101 in FIG. 1, the electronic device 201 in FIG. 2, and/or the electronic devices 301a to 301d in FIG. 3) may provide other widgets in addition to the collection widget, and the other widgets may be first widgets whose sizes are changeable, and may be displayed in a 2×1 size or a 4×1 size by default, and may further support a 3×1 size.

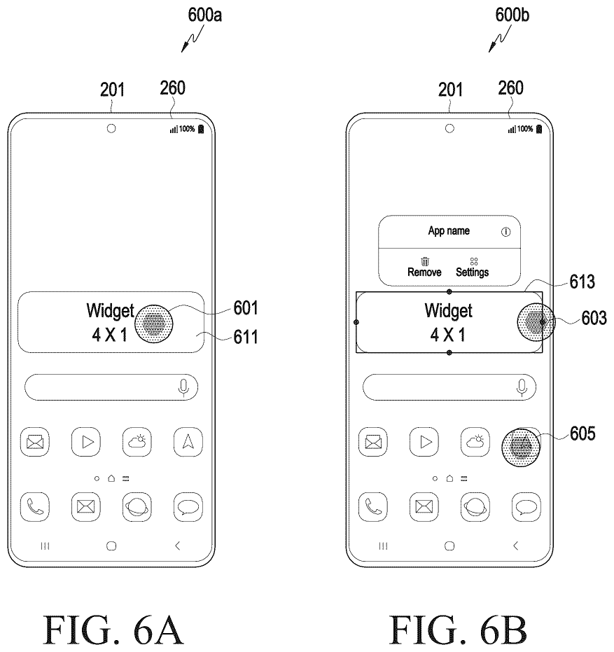

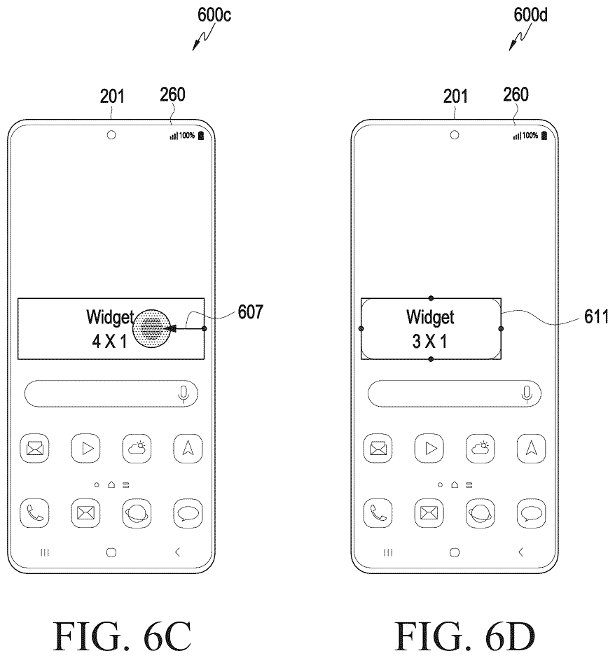

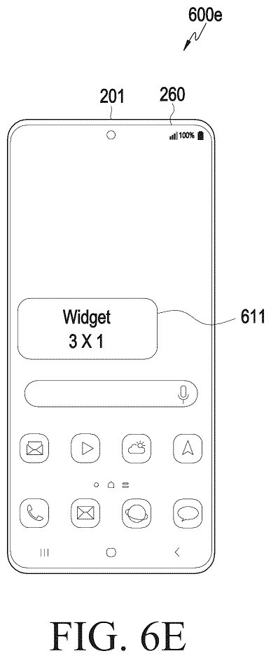

FIGS. 6A to 6E are diagrams illustrating an operation of displaying a first widget on a display of an electronic device according to various embodiments of the disclosure.

Referring to FIG. 6A, diagram 600a illustrates that, if a long press 601 is detected on a first widget 611 of 4×1 size displayed on a home screen while displaying the home screen on a display 260 (e.g., the display module 160 in FIG. 1 and/or the display 260 in FIG. 2), an electronic device 201 (e.g., the electronic device 101 in FIG. 1, the electronic device 201 in FIG. 2, and/or the electronic devices 301a to 301d in FIG. 3) may display a handler notifying that the first widget 611 is changeable in size.

Referring to FIGS. 6B and 6C, diagrams 600b and 600c illustrate that an electronic device 201 (e.g., the electronic device 101 in FIG. 1, the electronic device 201 in FIG. 2, and/or the electronic devices 301a to 301d in FIG. 3) may display a handler 613 indicating that the first widget 611 is changeable in size on the outline of the first widget 611 having a 4×1 size. If a touch 605 is detected in an area, other than the handler 613, while displaying the handler 613, the electronic device may release the display of the handler 613. The electronic device may detect a drag 607 to the left while touching 603, for example, a right point among the up/down/left/right points provided by the handler 613 to change the size of the first widget 611.

Referring to FIG. 6D, diagram 600d illustrates that, if an electronic device 201 (e.g., the electronic device 101 in FIG. 1, the electronic device 201 in FIG. 2, and/or the electronic devices 301a to 301d in FIG. 3) detects the drag 607 to the left while touching 603, for example, a right point among the up/down/left/right points provided by the handler 613 to change the size of the first widget, the electronic device 201 may reduce the size of the first widget to correspond to the movement in the direction of the left drag.

Referring to FIG. 6E, diagram 600e illustrates that, if the drag is not detected while reducing the size of the first widget to correspond to the movement in the left drag direction, an electronic device 201 (e.g., the electronic device 101 in FIG. 1, the electronic device 201 in FIG. 2, and/or the electronic devices 301a to 301d in FIG. 3) may release the display of the handler and display the first widget 611 that was changed to the 3×1 size.

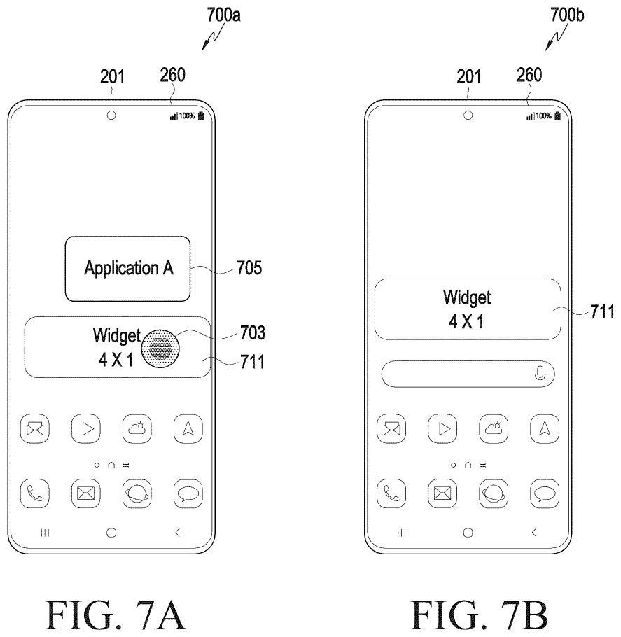

FIGS. 7A and 7B are diagrams illustrating an operation of displaying a second widget on a display of an electronic device according to various embodiments of the disclosure.

Referring to FIG. 7A to FIG. 7B, diagram 700a to 700b illustrate that an electronic device 201 (e.g., the electronic device 101 in FIG. 1, the electronic device 201 in FIG. 2, and/or the electronic devices 301a to 301d in FIG. 3) may detect a long press 703 on a second widget 711 of 4×1 size displayed on a home screen while displaying the home screen on a display 260 (e.g., the display module 160 in FIG. 1 and/or the display 260 in FIG. 2).

If an electronic device 201 (e.g., the electronic device 701 in FIG. 1, the electronic device in FIG. 2, and/or the electronic devices 301a to 301d in FIG. 3) detects the long press 703 on the second widget 711 of 4×1 size, since the second widget is unchangeable in size, the electronic device 201 may provide a brief description of an application corresponding to the second widget in the form of a pop-up 705 near the second widget, instead of displaying the handler indicating that the widget size is changeable on the outline of the second widget.

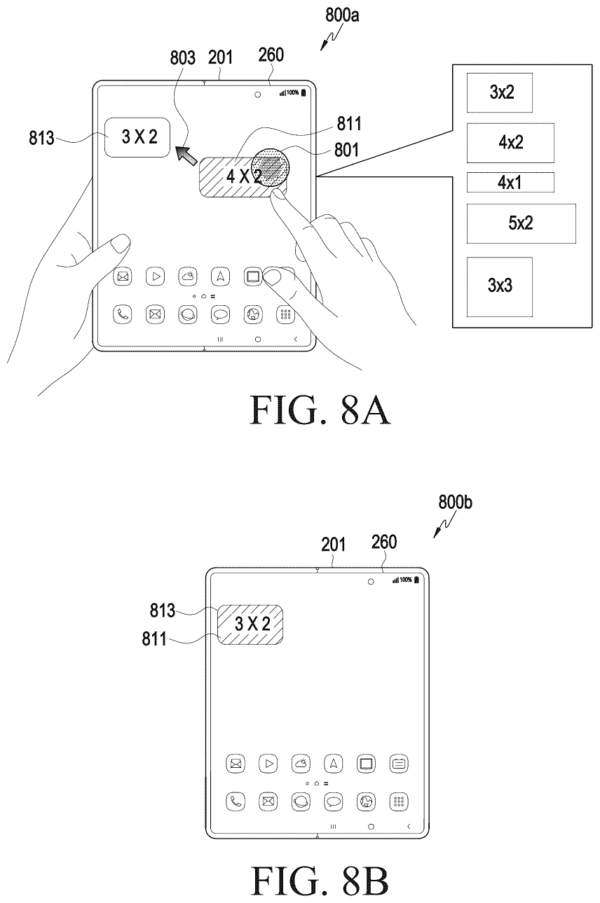

FIGS. 8A and 8B are diagrams illustrating an operation of overlapping widgets in an electronic device according to various embodiments of the disclosure.

Referring to FIG. 8A, diagram 800a illustrates that, if an electronic device 201 (e.g., the electronic device 101 in FIG. 1, the electronic device 201 in FIG. 2, and/or the electronic devices 301a to 301d in FIG. 3) identifies a first gesture 801 (e.g., a long press) on a widget 811, the electronic device 201 may identify, based on state information of the widget, that the widget 811 is a first widget whose size is changeable and that information about a plurality of sizes supported by the first widget is 3×2, 4×2, 4×1, 5×2, and 3×3. If the electronic device 201 detects a continuous second gesture 803 (e.g., drag and drop) for moving the widget 811 to a widget group 813 following the first gesture 801, the electronic device 201 may identify that a plurality of sizes supported by the widget 811 displayed in 4×2 on the home screen of a display 260 (e.g., the display 260 in FIG. 2) supports a size of 3×2, which is the size of the widget group.

Referring to FIG. 8B, diagram 800b illustrates that an electronic device 201 (e.g., the electronic device 101 in FIG. 1, the electronic device 201 in FIG. 2, and/or the electronic devices 301a to 301d in FIG. 3) may change the size of the widget 811 from 4×2 to 3×2, move it to the widget group 813, and display it to overlap the widget group.

For example, Table 1 below describes an operation of moving the first widget whose size is changeable to the widget group and display it to overlap the widget group.

TABLE 1

| | Size of first widget | |
|---|---|---|
| | displayed on home | |
| Size of widget group | screen | Operations |
| 3 × 2 | 3 × 2 | Move first widget to |
| | | widget group without |
| | | size change because of |
| | | same size |
| 3 × 2 | 4 × 2 | Change first widget to |
| | | 3 × 2 size and move it to |
| | | widget group |
| 3 × 2 | 4 × 1 | Change first widget to |
| | | 3 × 2 size and move it to |
| | | widget group |
| 3 × 2 | 5 × 2 | Change first widget to |
| | | 3 × 2 size and move it to |
| | | widget group |
| 3 × 2 | 3 × 3 | Change first widget to |
| | | 3 × 2 size and move it to |
| | | widget group |

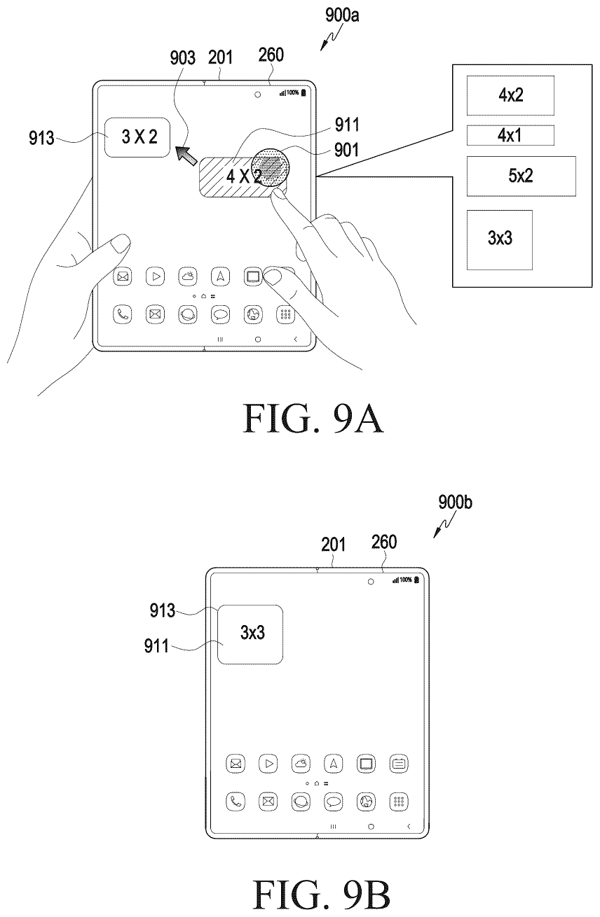

FIGS. 9A and 9B are diagrams illustrating an operation of overlapping widgets in an electronic device according to various embodiments of the disclosure.

Referring to FIG. 9A, diagram 900a illustrates that, if an electronic device 201 (e.g., the electronic device 101 in FIG. 1, the electronic device 201 in FIG. 2, and/or the electronic devices 301a to 301d in FIG. 3) identifies a first gesture 901 (e.g., a long press) on a widget 911, the electronic device 201 may identify, based on state information of the widget, that the widget 911 is a first widget whose size is changeable and that information about a plurality of sizes supported by the first widget is 4×2, 4×1, 5×2, and 3×3. If the electronic device 201 detects a continuous second gesture 903 (e.g., drag and drop) for moving the widget 911 to a widget group 913 following the first gesture 901, the electronic device 201 may identify that a plurality of sizes supported by the widget 911 displayed in 4×2 on the home screen of a display 260 (e.g., the display 260 in FIG. 2) does not support a size of 3×2, which is the size of the widget group.

Referring to FIG. 9B, diagram 900b illustrates that, if the smallest size among the plurality of sizes supported by a widget 911 is identified to be 3×3, an electronic device 201 (e.g., the electronic device 101 in FIG. 1, the electronic device 201 in FIG. 2, and/or the electronic devices 301a to 301d in FIG. 3) may change the size of widget group 913 from 3×2 to 3×3, change the size of the widget 911 from 4×2 to 3×3, and then move the widget 911 to widget group 813 so as to be displayed to overlap the widget group.

The electronic device may not perform an operation of moving the widget 911 to the widget group 913 if at least one widget included in the widget group 913 is unchangeable to 3×3.

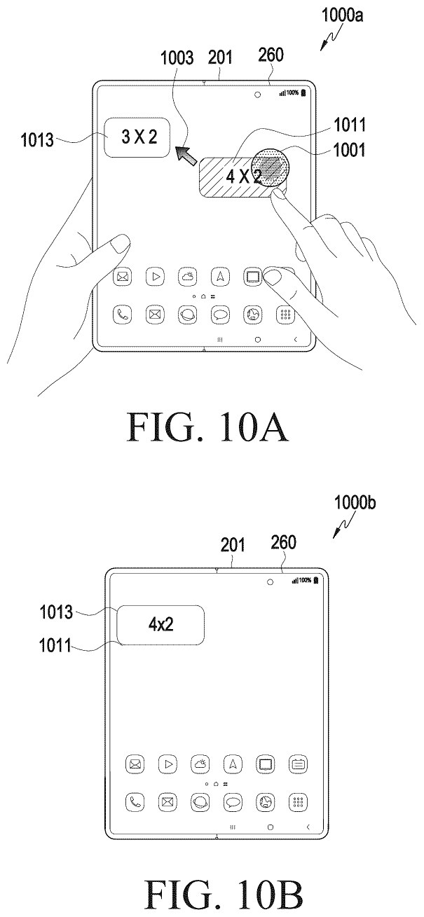

FIGS. 10A and 10B are diagrams illustrating an operation of overlapping widgets in an electronic device according to various embodiments of the disclosure.

Referring to FIG. 10A, diagram 1000a illustrates that, if an electronic device 201 (e.g., the electronic device 101 in FIG. 1, the electronic device 201 in FIG. 2, and/or the electronic devices 301a to 301d in FIG. 3) identifies a first gesture 1001 (e.g., a long press) on a widget 1011, the electronic device 201 may identify, based on state information of the widget, that the widget 1011 is a second widget whose size is unchangeable. The electronic device 201 may detect a continuous second gesture 1003 (e.g., drag and drop) for moving the widget 1011 to a widget group 1013 following the first gesture 1001.

Referring to FIG. 10B, diagram 1000b illustrates that an electronic device 201 (e.g., the electronic device 101 in FIG. 1, the electronic device 201 in FIG. 2, and/or the electronic devices 301a to 301d in FIG. 3) may change the size of the widget group 1013 from 3×2 to 4×2, then move the widget 1011 to the widget group 1013, and display it to overlap the widget group.

If at least one widget included in the widget group 1013 is unchangeable to 4×2, the electronic device may not perform an operation of moving the widget 1011 to the widget group 1013.

For example, Table 2 below describes an operation of moving a second widget whose size is unchangeable to a widget group and displaying it to overlap the widget group.

TABLE 2

| Size of widget group | Size of second | |
|---|---|---|
| (Size is changeable) | widget | Operations |
| 3 × 2 | 3 × 2 | Move second widget to |
| | | widget group without |
| | | size change because of |
| | | same size |
| 3 × 2 | 4 × 2 | Change size of widget |
| | | group to 4 × 2 size and |
| | | move second widget to |
| | | widget group |
| 3 × 2 | 4 × 1 | Change size of widget |
| | | group to 4 × 1 size and |
| | | move second widget to |
| | | widget group |
| 3 × 2 | 5 × 2 | Change size of widget |
| | | group to 5 × 2 size and |
| | | move second widget to |
| | | widget group |
| 3 × 2 | 3 × 3 | Change size of widget |
| | | group to 3 × 3 size and |
| | | move second widget to |
| | | widget group |

For example, Table 3 below describes an operation of moving a first widget whose size is changeable and a second widget whose size is unchangeable to a widget group and displaying them to overlap the widget group.

TABLE 3

| Size of widget group | Sizes of first and second | |
|---|---|---|
| (Size is changeable) | widgets | Operations |
| 3 × 2 | 3 × 2 (size of first widget | Move first widget to |
| | displayed on display) | widget group without |
| | | size change because of |
| | | same size |
| 3 × 2 | 4 × 2 (size of second | Impossible to overlap |
| | widget) | |
| 3 × 2 | 4 × 1 (size of second | Impossible to overlap |
| | widget) | |
| 3 × 2 | 5 × 2 (size of first widget | Change first widget to |
| | displayed on display) | 3 × 2 size and move it to |
| | | widget group |
| 3 × 2 | 3 × 3 (size of first widget | Change first widget to |
| | displayed on display) | 3 × 2 size and move it to |
| | | widget group |

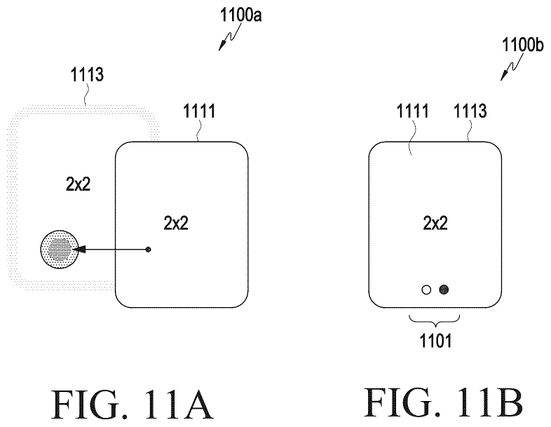

FIGS. 11A and 11B are diagrams illustrating a widget group in an electronic device according to various embodiments of the disclosure.

Referring to FIG. 11A, diagram 1100a illustrates that, if an electronic device (e.g., the electronic device 101 in FIG. 1, the electronic device 202 in FIG. 2, and/or the electronic devices 301a to 301d in FIG. 3) detects a continuous second gesture (e.g., drag and drop) for moving to a widget group 1113 following a first gesture (e.g., long press) on a widget 1111, since the widget 1111 and the widget group 1113 have the same size, the electronic device may move the widget 1111 to the widget group 1113 and display it to overlap the widget group.

Referring to FIG. 11B, diagram 1100b illustrates that an electronic device (e.g., the electronic device 101 in FIG. 1, the electronic device 201 in FIG. 2, and/or the electronic devices 301a to 301d in FIG. 3) may display an indicator 1101 indicating the number of widgets included in the widget group in at least a partial area of the widget 1111 while displaying the widget 1111 overlapping the widget group 1113.

According to an embodiment, if a new widget overlaps the widget group, the electronic device may display an indicator indicating the number of widgets included in the widget group and may release the display of the indicator after a predetermined period of time elapses.

For example, when displaying a home screen on which the widget group is displayed, among a plurality of home screens (e.g., when displaying a home screen on which the widget group is displayed by swiping left and right, displaying a home screen on which the widget group is displayed by input to a home key while executing a specific application, or displaying a home screen on which the widget group is displayed after unlocking the electronic device), the electronic device may display the indicator 1101 indicating the number of widgets included in the widget group and release the display of the indicator 1101 after a predetermined period of time elapses.

For example, when displaying a quick option, based on a first gesture (e.g., long press) detected on the widget group, the electronic device may display the indicator 1101 indicating the number of widgets included in the widget group and release the display of the indicator 1101 when the display of the quick option is released.

For example, if a second gesture (e.g., drag and drop) for overlapping a new widget on the widget group is detected, the electronic device may display the indicator 1101 indicating the number of widgets for each of all widget groups, where the second gesture occurred, displayed on the home screen and release the indicator 1101 when the second gesture ends.

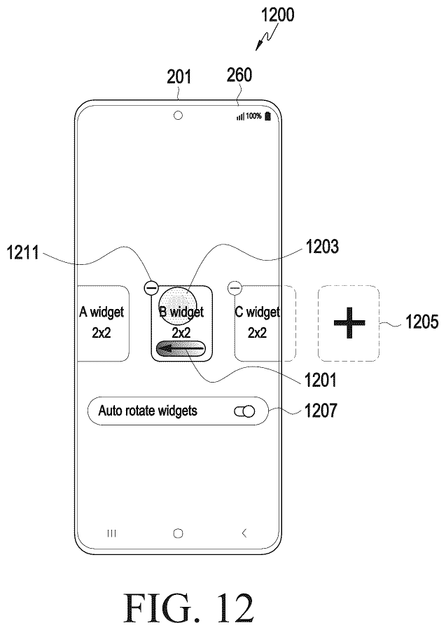

FIG. 12 is a diagram illustrating an edit mode of a widget in an electronic device according to an embodiment of the disclosure.

Referring to FIG. 12, diagram 1200 illustrates that an electronic device 201 (e.g., the electronic device 101 in FIG. 1, the electronic device 201 in FIG. 2, and/or the electronic devices 301a to 301d in FIG. 3) may display a quick option if a first gesture (1203) (e.g., long press) is detected on a widget group, and may enter an edit mode of the widget group, based on selection of an edit button of the widget group provided in the quick option.

The electronic device 201 may detect a second gesture (e.g., drag and drop) for moving a new widget to the widget group to overlap the same, and may display, if the second gesture is released within a predetermined period of time, the new widget overlapping the widget group and, if the second gesture is not released within a predetermined period of time, enter an edit mode of the widget group.

In the edit mode of the widget group, the electronic device 201 may display an indicator 1211 indicating a widget removal function in each displayed widget while sequentially displaying the plurality of widgets, based on a third gesture 1201 (e.g., left and right swipe) detected on the widget group. The electronic device 201 may delete a widget of which the indicator 1211 indicating the widget removal function is selected.

The electronic device 201 may change the order of a widget selected by a long press, among the plurality of widgets included in the widget group, based on a long-press and move detected on the displayed widget while sequentially displaying the plurality of widgets, based on the third gesture 1201 (e.g., left and right swipe) detected on the widget group. If the widget where the long press is detected moves beyond a predetermined area, the electronic device 201 may display the widget on a home screen of the display 260 without including it in the widget group. If the widget is identified to be a widget whose size has changed while being included in the widget group, the electronic device 201 may change the widget to the size before the change and display it on the home screen of the display 260.

The electronic device 201, in the edit mode of the widget group, may provide a widget addition button 1205 for adding a new widget in the last order while sequentially displaying the plurality of widgets, based on a third gesture (e.g., left and right swipe) detected on the widget group. If selection of the widget addition button 1205 is identified, the electronic device 201 may filter a widget that is changeable to a size smaller than or equal to the size of the widget group (e.g., the first widget whose size is changeable) or a widget that has a size smaller than or equal to the size of the widget group (e.g., the second widget whose size is unchangeable) and provide it to the user. The electronic device 201 may arrange the widget, which is newly added through the widget addition function, in the last order.

The electronic device 201, in the edit mode of the widget group, may configure activation or deactivation of a function 1207 of auto-rotating widgets for moving to the widget corresponding to a currently running application and displaying.

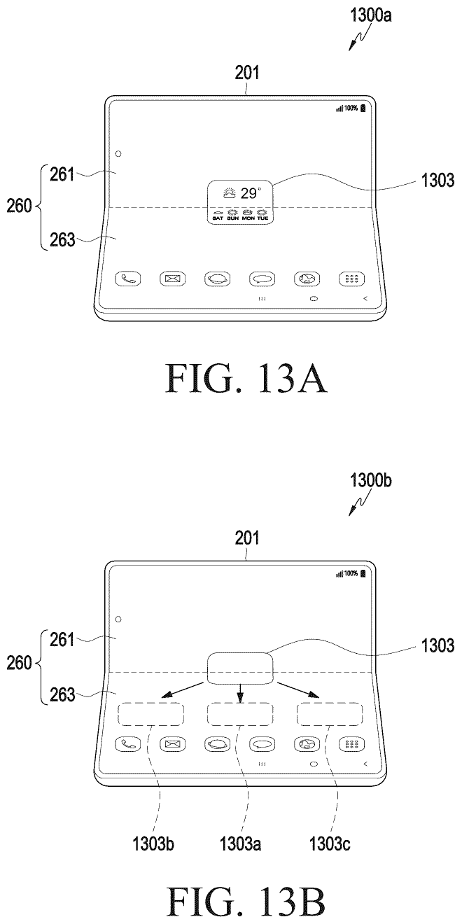

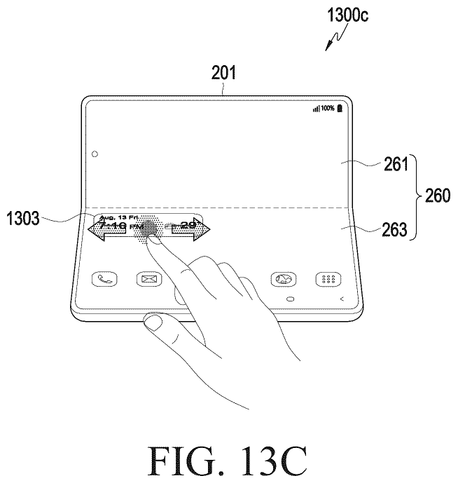

FIGS. 13A to 13C are diagrams illustrating an operation of controlling a widget in a folded state of an electronic device according to various embodiments of the disclosure.

Referring to FIG. 13A, diagram 1300a illustrates that an electronic device 201 (e.g., the electronic device 101 in FIG. 1, the electronic device 201 in FIG. 2, and/or the electronic devices 301a to 301d in FIG. 3) may detect a first folded state (e.g., half-folded state) of the electronic device in which the electronic device 201 is folded at a predetermined angle (e.g., 80 degrees to 130 degrees) from an unfolded state, based on a signal received from a sensor module (e.g., the sensor module 276 in FIG. 2). In the first folded state of the electronic device, the electronic device 201 may identify the display of at least a part of the widget group in an area where the first display 261 and the second display 263 face each other.

Referring to FIG. 13B, diagram 1300b illustrates that, if an electronic device 201 (e.g., the electronic device 101 in FIG. 1, the electronic device 201 in FIG. 2, and/or the electronic devices 301a to 301d in FIG. 3) identifies the display of at least a part of the widget group in the area where a first display 261 and a second display 263 face each other in the first folded state of the electronic device, the electronic device 201 may identify that the first display 261 is used as a display unit and the second display 263 is used as an input unit in the flex mode.

The electronic device 201 may determine a plurality of areas 1303a, 1303b, and 1303c having a plurality of coordinates, as starting coordinates, in which a widget group 1303 may be moved and displayed on the second display 263 used as an input unit. The electronic device 201 may determine a first area 1303a having a first coordinate (X2, Y2), as a starting coordinate, positioned closest to the starting coordinate (X0, Y0) of the area where the widget group 1303 is positioned, among the plurality of areas 1303a, 1303b, and 1303c, to be the area where the widget group 1303 is to be displayed.

If there is an existing icon or widget in the first area 1303a, the electronic device 201 may move and display the widget group 1303 to and on a second area 1303b having a second coordinate, as a starting coordinate, that is the next closest after the first area 1303a to the starting coordinate (X0, Y0) of the area where the widget group 1303 is positioned, among the plurality of areas.

Referring to FIG. 13C, diagram 1300c illustrates that an electronic device 201 (e.g., the electronic device 101 in FIG. 1, the electronic device 201 in FIG. 2, and/or the electronic devices 301a to 301d in FIG. 3), when moving a widget group 1303 positioned in an area where a first display 261 and a second display 263 face each other to the second area 1303b on the second display 263 in the first folded state of the electronic device, may change a widget group of a 3×3 size to a 4×4 size corresponding to the size of the second area 1303b of the second display 263 and then display it on the second area 1303b.

The electronic device 201, based on a third gesture (e.g., left and right swipe) detected on the widget group 1303 that was moved and displayed on the second display 263, may sequentially display the plurality of widgets included in the widget group.

The electronic device 201, based on a third gesture (e.g., left and right swipe) detected on the widget group 1303 that was moved and displayed on the second display 263, may sequentially display the plurality of widgets included in the widget group by allowing looping in one direction (e.g., rightward direction).

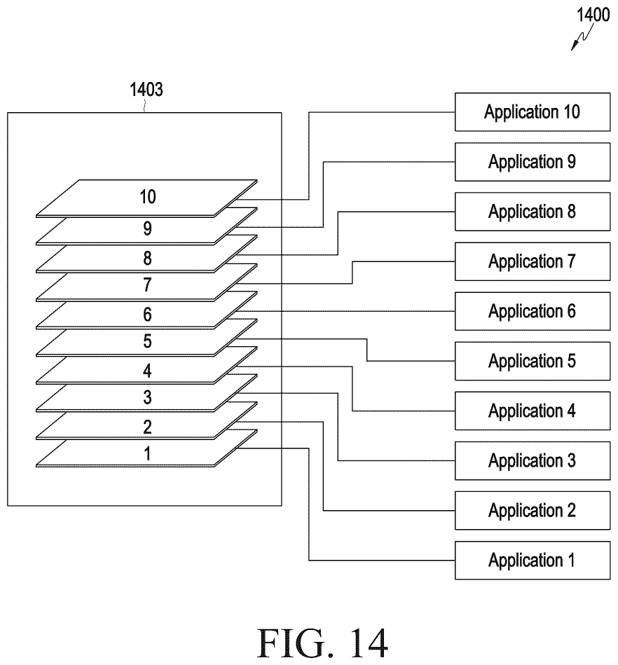

FIG. 14 is a diagram illustrating an operation of updating a size of a widget group in an electronic device according to an embodiment of the disclosure.

Referring to FIG. 14, diagram 1400 illustrates that, if the sizes of a plurality of widgets (widget 1 to widget 10) included in a widget group 1403 are simultaneously changed and updated, a plurality of applications (application 1 to application 10) respectively corresponding to the plurality of widgets must be simultaneously executed, and thus, a load may occur on the main thread due to the time required for the simultaneous execution of the plurality of applications (application 1 to application 10).

When changing the sizes of the plurality of widgets (widget 1 to widget 10) included in the widget group 1403, an electronic device (e.g., the electronic device 101 in FIG. 1, the electronic device 201 in FIG. 2, and/or the electronic devices 301a to 301d in FIG. 3) may change and update the size of a widget (widget 1) displayed as the widget group, and then sequentially change and update the sizes of the remaining widgets (widget 2 to widget 10), thereby distributing the load of the main thread to improve a frame drop on the screen.

If the electronic device detects a first folded state (e.g., half-folded state) of the electronic device in which the electronic device is folded at a predetermined angle (e.g., 80 degrees to 130 degrees) while managing a widget group displayed on an external display provided outside a housing of the electronic device and the widget group displayed on a display (e.g., the display 260 in FIG. 2) as a pair, the electronic device may hide the widget group displayed on the display, instead of changing the size of the widget group to display the widget group displayed on the display through the first display or the second display of the display, and display the widget group, displayed on the external display, on the first display or the second display of the display.

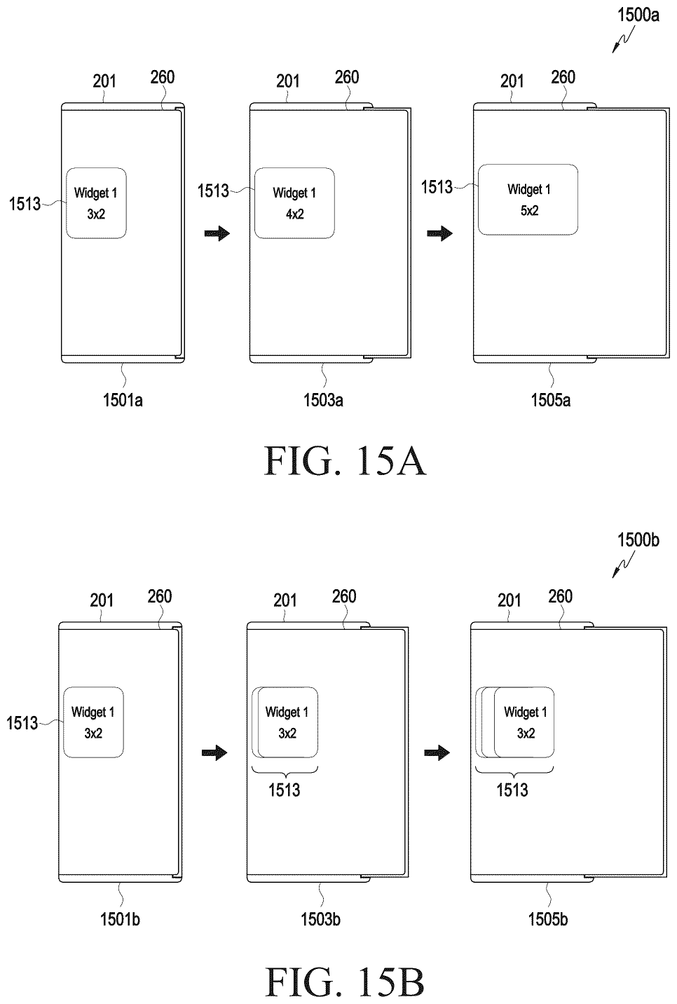

FIGS. 15A and 15B are diagrams illustrating an operation of controlling a widget group depending on a change in a display size of an electronic device according to various embodiments of the disclosure.

Referring to FIG. 15A, diagram 1500a illustrates that, as shown in a screen 1501a, an electronic device 201 (e.g., the electronic device 101 in FIG. 1, the electronic device 201 in FIG. 2, and/or the electronic devices 301a to 301d in FIG. 3) may detect an expansion of a display 260 (e.g., the display 260 in FIG. 2) in the horizontal direction while displaying a widget group 1513 of a 3×2 size on the display 260 of the electronic device.

As shown in a screen 1503a, if a horizontal expansion of the display 260 to a predetermined extent is detected, the electronic device 201 may identify the size (e.g., 4×2) of a widget configured according to the size of the display and change the 3×2 size of the widget group 1513 to a 4×2 size. The electronic device 201 may change the size of a widget displayed as the widget group, among a plurality of widgets included in the widget group 1513, to a 4×2 size and update the same, and may sequentially change the remaining widgets to a 4×2 size and update the same.

As shown in a screen 1505a, if the electronic device 201 detects a further expansion of the display 260 in the horizontal direction to a predetermined extent, the electronic device 201 may identify the size (e.g., 5×2) of a widget configured according to the size of the display and change the 4×2 size of the widget group 1513 to a 5×2 size. The electronic device 201 may change the size of the widget displayed as the widget group, among the plurality of widgets included in the widget group 1513, to a 5×2 size and update the same, and may sequentially change the remaining widgets to a 5×2 size and update the same.

Referring to FIG. 15B, diagram 1500b illustrates that, as shown in a screen 1501b, an electronic device 201 (e.g., the electronic device 101 in FIG. 1, the electronic device 201 in FIG. 2, and/or the electronic devices 301a to 301d in FIG. 3) may detect an expansion of a display 260 (e.g., the display 260 in FIG. 2) in the horizontal direction while displaying a widget group 1513 on the display 260 of the electronic device.

As shown in a screen 1503b, if a horizontal expansion of the display 260 to a predetermined extent is detected, the electronic device 201 may identify the number of widgets (e.g., 2) configured according to the size of the display and display two widgets among the plurality of widgets included in the widget group 1513.

As shown in a screen 1505b, if a further horizontal expansion of the display 260 to a predetermined extent is detected, the electronic device 201 may identify the number of widgets (e.g., 3) configured according to the size of the display and may display three widgets among the plurality of widgets included in the widget group 1513.

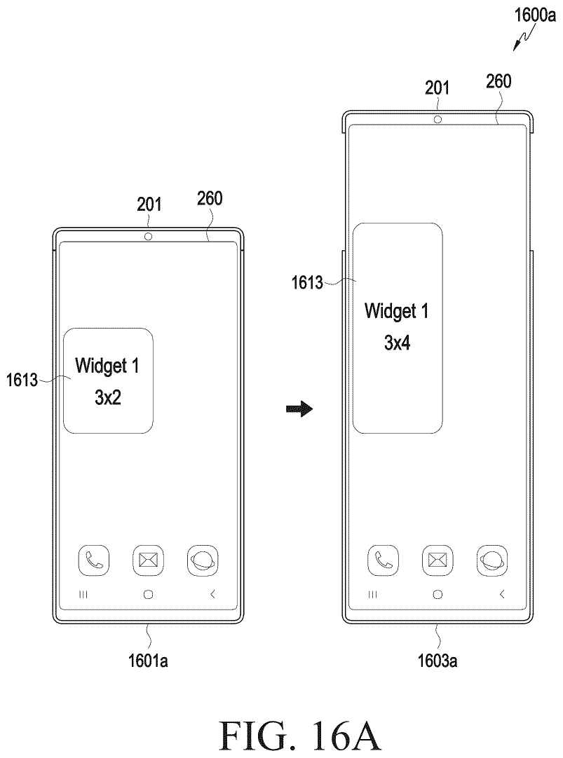

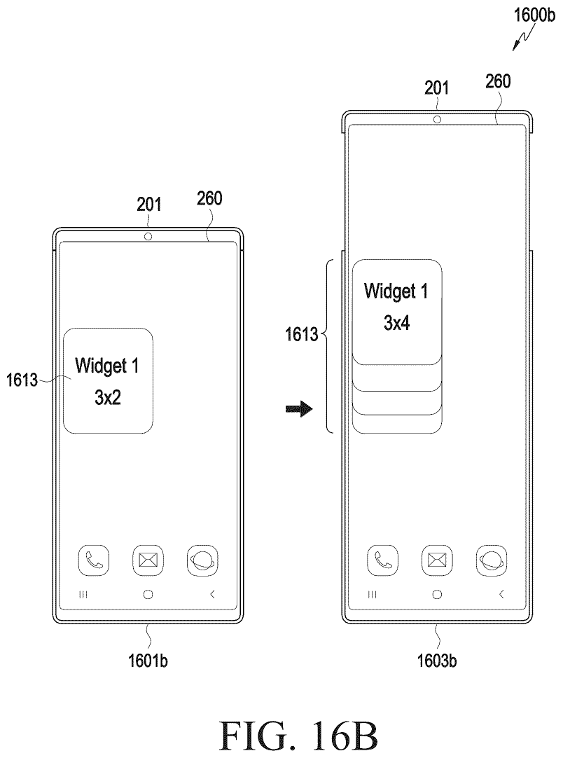

FIGS. 16A and 16B are diagrams illustrating an operation of controlling a widget group according to a change in a display size of an electronic device according to various embodiments of the disclosure.

Referring to FIG. 16A, diagram 1600a illustrates that, as shown in a screen 1601a, an electronic device 201 (e.g., the electronic device 101 in FIG. 1, the electronic device 201 in FIG. 2, and/or the electronic devices 301a to 301d in FIG. 3) may detect an expansion of a display 260 (e.g., the display 260 in FIG. 2) in the vertical direction while displaying a widget group 1613 of a 3×2 size on the display 260 of the electronic device.

As shown in a screen 1603a, if a vertical expansion of the display 260 to a predetermined extent is detected, the electronic device 201 may identify the size (e.g., 3×4) of a widget configured according to the size of the display and change the 3×2 size of the widget group 1613 to a 3×4 size. The electronic device 201 may change the size of the widget displayed as the widget group, among the plurality of widgets included in the widget group 1613, to a 3×4 size and update the same, and may sequentially change the remaining widgets to a 3×4 size and update the same.

Referring to FIG. 16B, diagram 1600b illustrates that, as shown in a screen 1601b, an electronic device 201 (e.g., the electronic device 101 in FIG. 1, the electronic device 201 in FIG. 2, and/or the electronic devices 301a to 301d in FIG. 3) may detect an expansion of a display 260 (e.g., the display 260 in FIG. 2) in the vertical direction while displaying a widget group 1613 on the display 260 of the electronic device.

As shown in a screen 1603b, if a vertical expansion of the display 260 to a predetermined extent is detected, the electronic device 201 may display a plurality of widgets included in the widget group 1513.

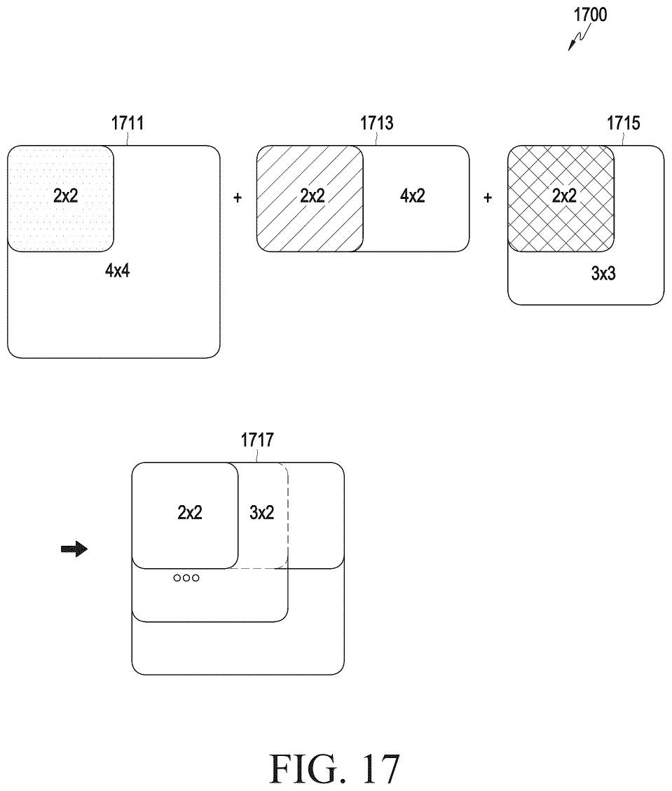

FIG. 17 is a diagram illustrating an operation of determining a size of a widget group in an electronic device according to an embodiment of the disclosure.

Referring to FIG. 17, diagram 1700 illustrates that, if a first widget A 1711 supporting a 2×2 size and a 4×4 size, a first widget B 1713 supporting a 2×2 size and a 4×2 size, and a first widget C 1715 supporting a 2×2 size and a 3×3 size overlap to produce a widget group, an electronic device (e.g., the electronic device 101 in FIG. 1, the electronic device 201 in FIG. 2, and/or the electronic devices 301a to 301d in FIG. 3) may determine a 3×2 size, which corresponds to an intersection of a plurality of sizes supported by the first widget A 1711, a plurality of sizes supported by the first widget B 1713, and a plurality of sizes supported by the first widget C 1715, to be the size of a widget group 1717.

The electronic device may change the first widget A 1711, the first widget B 1713, and the first widget C 1715 to a 3×2 size determined as the size of the widget group 1717 and then display the widget group 1717 on a display (e.g., the display 260 in FIG. 2).

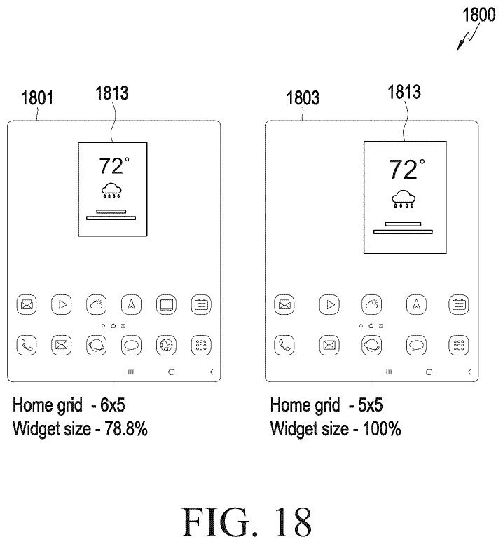

FIG. 18 is a diagram illustrating an operation of determining a size of a widget group in an electronic device according to an embodiment of the disclosure.

Referring to FIG. 18, diagram 1800 illustrates that, as shown in a screen 1801, an electronic device (e.g., the electronic device 101 in FIG. 1, the electronic device 201 in FIG. 2, and/or the electronic devices 301a to 301d in FIG. 3) may display a widget group 1813 of a 3×5 size on a home screen if the home screen displayed on a display (e.g., the display 260 in FIG. 2) is configured as a basic grid of 6×5.

As shown in a screen 1803, when configuring the grid of the home screen by changing it from a 6×5 grid to a 5×5 grid, the electronic device may display the widget group 1813 of 3×5 in a larger size on the home screen configured as the 5×5 grid than on the home screen configured as the 6×5 grid. If the 3×5 size of the widget group 1813 displayed on the home screen configured as the 5×5 grid is considered 100%, the 3×5 size of the widget group 1813 displayed on the home screen configured as the 6×5 grid may be considered 78.8%.

Referring to FIGS. 4A and 4B, one of various grids may be configured as the layout of the home screen.

The size of the widget displayed on the home screen may vary depending on the size of the grid configured in the home screen, and a widget of the same size (a widget of a 3×5 size) may be displayed to be enlarged on a home screen configured as a grid type with a smaller number of grids (5×5 grid) than on a home screen configured as a grid type with a larger number of grids (6×5 grid).

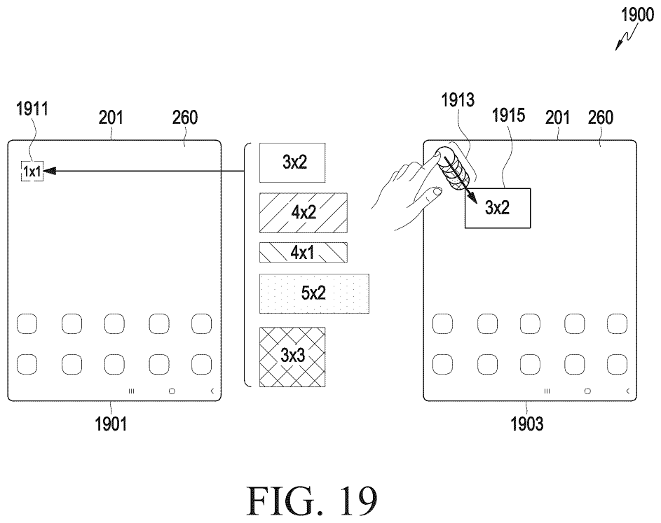

FIG. 19 is a diagram illustrating an operation of displaying a widget group in an electronic device according to an embodiment of the disclosure.

Referring to FIG. 19, diagram 1900 illustrates that, as shown in a screen 1901, an electronic device 201 (e.g., the electronic device 101 in FIG. 1, the electronic device 201 in FIG. 2, and/or the electronic devices 301a to 301d in FIG. 3) may display an icon 1911 representing a widget group in a predetermined area (e.g., a small area having a size of 1×1) of a home screen displayed on a display 260 (e.g., the display 260 in FIG. 2).

As shown in a screen 1903, if a touch is detected on the icon 1911, the electronic device may display a plurality of widgets included in the widget group in the form of a pop-up 1913 on the predetermined area where the icon 1911 is displayed. If a selection for a widget 1915 positioned at the top from among the plurality of widgets is identified while displaying the plurality of widgets in the form of the pop-up 1913, the electronic device may display the selected widget 1915 on the display 260.

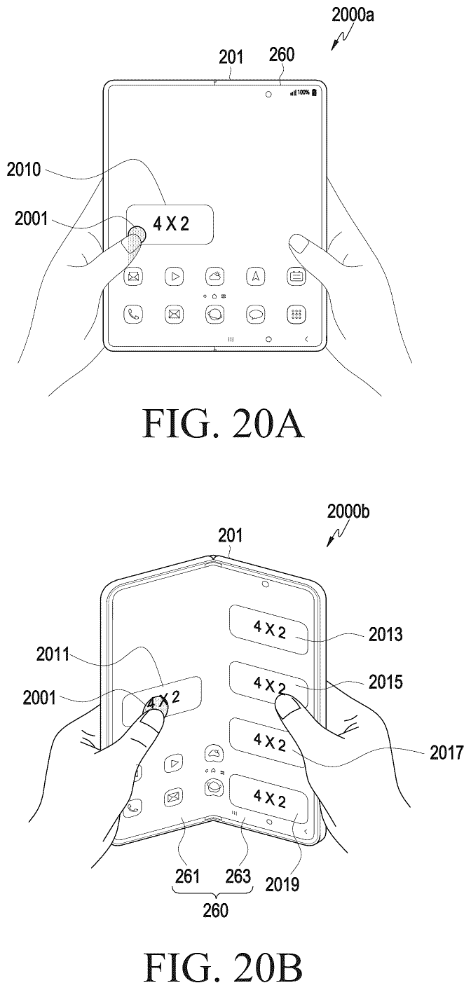

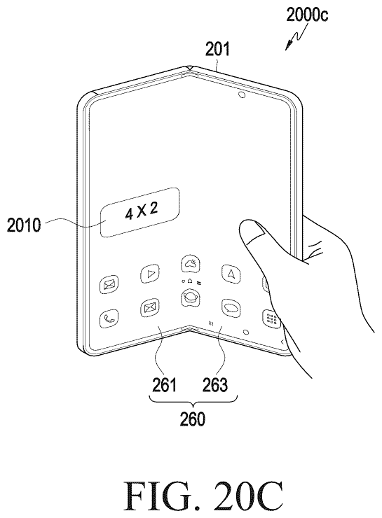

FIGS. 20A to 20C are diagrams illustrating an operation of displaying a widget group in an electronic device according to various embodiments of the disclosure.

Referring to FIG. 20A, diagram 2000a illustrates that an electronic device 201 (e.g., the electronic device 101 in FIG. 1, the electronic device 201 in FIG. 2, and/or the electronic devices 301a to 301d in FIG. 3) may detect a long press 2001 on a widget group 2010 while displaying the widget group 2010 on a display 260 (e.g., the display 260 in FIG. 2) in an unfolded state of the electronic device.

Referring to FIG. 20B, diagram 2000b illustrates that, if an electronic device 201 detects folding of the electronic device 201 while detecting a long press 2001 on the widget group 2010, the electronic device 201 may display widget E 2011, which was displayed as a widget group, at the position of a first display 261 of the display 260 where the widget group 2010 was disposed, and sequentially display the remaining widgets, i.e., widget A 2013, widget B 2015, widget C 2017, and widget D 2019, which overlapped each other and were not displayed, on the second display 263 of the display 260.

Referring to FIG. 20C, diagram 2000c illustrates that, if an electronic device 201 does not detect a long press while displaying all of the plurality of widgets included in the widget group 2010 on the display 260 in the folded state of the electronic device, the electronic device 201 may release the display of the plurality of widgets, widget A 2013, widget B 2015, widget C 2017, and widget D 2019, and display the widget group 2010 displaying widget E 2011 on the first display 261.

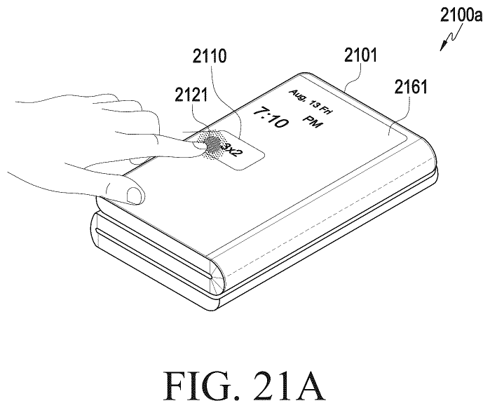

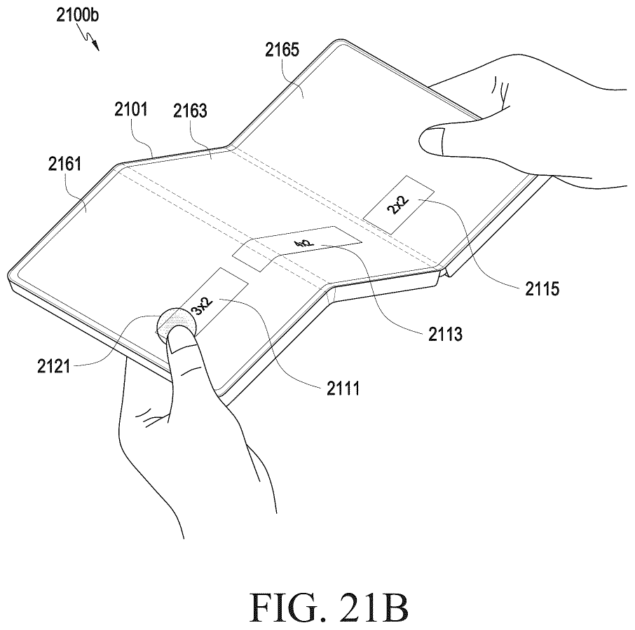

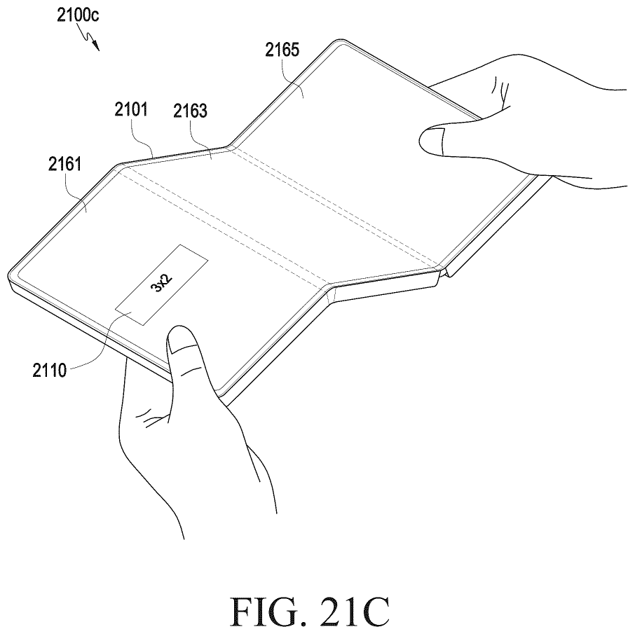

FIGS. 21A to 21C are diagrams illustrating an operation of displaying a widget group in an electronic device according to various embodiments of the disclosure.

Referring to FIG. 21A, diagram 2100a illustrates that an electronic device 2101 (e.g., the electronic device 101 in FIG. 1, the electronic device 201 in FIG. 2, and/or the electronic devices 301a to 301d in FIG. 3) may detect a long press 2121 on a widget group 2110 while displaying the widget group 2110 on a first display 2161 (e.g., the display in FIG. 1) of the display when the electronic device is in the folded state.

Referring to FIG. 21B, diagram 2100b illustrates that, if an electronic device 2101 detects unfolding of the electronic device 2101 while detecting a long press 2121 on a widget group 2110, the electronic device 2101 may display widget A 2111, which was displayed as a widget group, at the position of the first display 2161 where the widget group 2110 was disposed, and sequentially display the remaining widgets, i.e., widget B 2113 and widget C 2115, which overlapped each other and were not displayed, on a second display 2163 connected to the first display 2161 and a third display 2165 connected to the second display 2163.

Referring to FIG. 21C, diagram 2100c illustrates that, if an electronic device 2101 does not detect a long press while displaying all of the plurality of widgets included in the widget group 2110 on the first display 2161, the second display 2163, and the third display 2165 in the unfolded state of the electronic device, the electronic device 2101 may release the display of the plurality of widgets, i.e., widget B 2113 and widget C 2115, and display the widget group 2110 displaying widget A 2111 on the first display 2161.

According to an embodiment, an electronic device (e.g., the electronic device 101 in FIG. 1, the electronic device 201 in FIG. 2, or one of the electronic devices 301a to 301d in FIG. 3) may include a display (e.g., the display module 160 in FIG. 1 or the display 260 in FIG. 2) and a processor (e.g., the processor 120 in FIG. 1 or the processor 220 in FIG. 2).

According to an embodiment, the processor (e.g., the processor 120 in FIG. 1 or the processor 220 in FIG. 2) configured to identify, when identifying movement of a widget displayed on the display to a widget group, whether there is a size smaller than or equal to a first size corresponding to a size of the widget group among at least one size supported by the widget.

According to an embodiment, the processor (e.g., the processor 120 in FIG. 1 or the processor 220 in FIG. 2) configured to change, if there is a size smaller than or equal to the first size of the widget group among the at least one size supported by the widget, the widget to the size smaller than or equal to the first size of the widget group, and move the resized widget to the widget group and display it to overlap the widget group.

According to an embodiment, the processor (e.g., the processor 120 in FIG. 1 or the processor 220 in FIG. 2) is configured to identify, if a widget displayed on the display is a first widget whose size is changeable, and if the size of the first widget is not the same as the first size of the widget group, whether there is a size smaller than or equal to the first size of the widget group among a plurality of sizes supported by the first widget.

According to an embodiment, the processor (e.g., the processor 120 in FIG. 1 or the processor 220 in FIG. 2) is configured to change, if there is a size smaller than or equal to the first size of the widget group among the plurality of sizes supported by the first widget, the first widget to the size smaller than or equal to the first size of the widget group, and move the resized first widget to the widget group and display it to overlap the widget group.

According to an embodiment, the processor (e.g., the processor 120 in FIG. 1 or the processor 220 in FIG. 2) is configured to move, if a current size of the first widget displayed on the display (e.g., the display module 160 in FIG. 1 or the display 260 in FIG. 2) is the same as the first size of the widget group, the first widget to the widget group without changing the size of the first widget and display it to overlap the widget group.

According to an embodiment, the processor (e.g., the processor 120 in FIG. 1 or the processor 220 in FIG. 2) is configured to move, if the widget displayed on the display (e.g., the display module 160 in FIG. 1 or the display 260 in FIG. 2) is a second widget whose size is unchangeable, and if the size of the second widget is the same as the first size of the widget group, the widget to the widget group and display it to overlap the widget group.

According to an embodiment, the processor (e.g., the processor 120 in FIG. 1 or the processor 220 in FIG. 2) is configured to identify, if the widget displayed on the display (e.g., the display module 160 in FIG. 1 or the display 260 in FIG. 2) is a first widget whose size is changeable, and if it is identified that there is no size smaller than or equal to the first size of the widget group among the plurality of sizes supported by the first widget, a second size corresponding to the smallest size among the plurality of sizes supported by the first widget.

According to an embodiment, the processor (e.g., the processor 120 in FIG. 1 or the processor 220 in FIG. 2) is configured to change the size of the widget group from the first size to the second size, change the second widget to the second size, move the second widget changed to the second size to the widget group, and display it to overlap the widget group.

According to an embodiment, the processor (e.g., the processor 120 in FIG. 1 or the processor 220 in FIG. 2) is configured to identify at least one size supported by each of at least one widget included in the widget group.

According to an embodiment, the processor (e.g., the processor 120 in FIG. 1 or the processor 220 in FIG. 2) is configured to identify whether the at least one widget is changeable to the second size, based on the at least one size supported by each of the at least one widget.

According to an embodiment, the processor (e.g., the processor 120 in FIG. 1 or the processor 220 in FIG. 2) is configured to change, if the at least one widget is changeable to the second size, the widget group including the at least one widget to the second size.

According to an embodiment, the processor (e.g., the processor 120 in FIG. 1 or the processor 220 in FIG. 2) is configured to change, if the widget displayed on the display (e.g., the display module 160 in FIG. 1 or the display 260 in FIG. 2) is a second widget whose size is unchangeable, and if the size of the second widget is not smaller than or equal to the first size of the widget group, the size of the widget group from the first size to the size of the second widget, move the second widget to the widget group, and display it to overlap the widget group.

According to an embodiment, the processor (e.g., the processor 120 in FIG. 1 or the processor 220 in FIG. 2) is configured to identify at least one size supported by each of at least one widget included in the widget group.

According to an embodiment, the processor (e.g., the processor 120 in FIG. 1 or the processor 220 in FIG. 2) is configured to identify whether the at least one widget is changeable to the size of the second widget, based on the at least one size supported by each of the at least one widget.

According to an embodiment, the processor (e.g., the processor 120 in FIG. 1 or the processor 220 in FIG. 2) is configured to change, if the at least one widget is changeable to the size of the second widget, the widget group including the at least one widget to the size of the second widget.

According to an embodiment, if display of at least a part of the widget group is identified in an area where a first display (e.g., the first display 261 in FIG. 2) and a second display (e.g., the second display 263 in FIG. 2) included in the display face each other when detecting a first folded state of the electronic device in which the electronic device is folded at a predetermined angle, the processor (e.g., the processor 120 in FIG. 1 or the processor 220 in FIG. 2) is configured to move and display the widget group to and on the first display or the second display.

According to an embodiment, the processor (e.g., the processor 120 in FIG. 1 or the processor 220 in FIG. 2) is configured to change the size of the widget group and display it, based on the number or sizes of icons disposed on the first display (e.g., the first display 261 in FIG. 2) or the second display (e.g., the second display 263 in FIG. 2) included in the display, when moving the widget group to one of the first display and the second display.

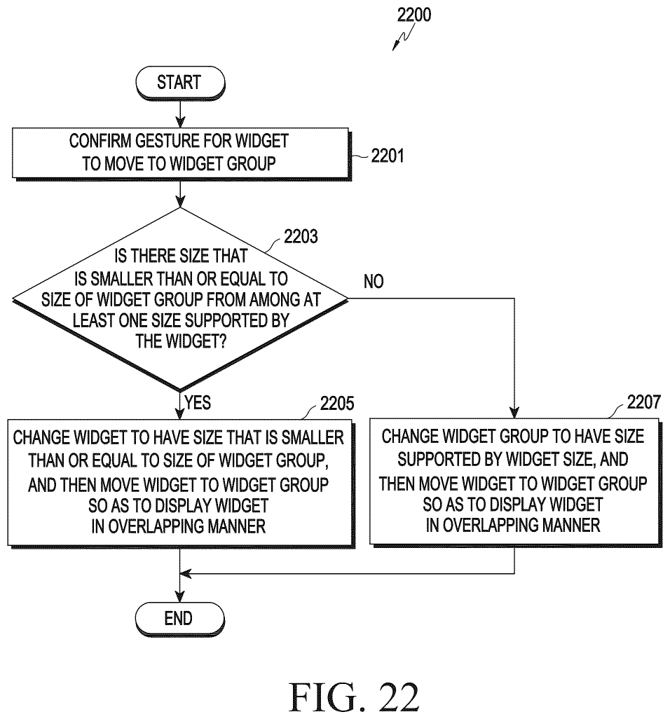

FIG. 22 is a flowchart illustrating an operation of grouping a plurality of widgets in an electronic device according to an embodiment of the disclosure. The operations of grouping the plurality of widgets may include operations 2201 to 2207. According to an embodiment, at least one of operations 2201 to 2207 may be omitted, the order of some operations may vary, or other operations may be added thereto.

Referring to FIG. 22, flowchart 2200 illustrates that, in operation 2201, an electronic device (e.g., the electronic device 101 in FIG. 1, the electronic device 201 in FIG. 2, and/or the electronic devices 301a to 301d in FIG. 3) may identify a gesture for moving a widget to a widget group.

According to an embodiment, if the electronic device identifies a first gesture (e.g., a long press or multi-long press) on the widget displayed on the display (e.g., the display 260 in FIG. 2) and identifies a continuous second gesture (e.g., a drag and drop) following the first gesture, the electronic device may identify movement of the widget to a position where the widget group is disposed.

According to an embodiment, the widget group may include a plurality of widgets and may indicate one widget that is to be moved.

According to an embodiment, the electronic device may detect state information of the widget if the first gesture (e.g., a long press or multi-long press) is identified on the widget. Based on the state information of the widget, the electronic device may determine whether the widget is a first widget whose size is changeable or a second widget whose size is unchangeable. Based on the state information of the widget, the electronic device may identify a plurality of sizes supported by the first widget and identify a size of the second widget.

In operation 2203, the electronic device (e.g., the electronic device 101 in FIG. 1, the electronic device in 201 FIG. 2, and/or the electronic devices 301a to 301d in FIG. 3) may identify whether there is a size that is smaller than or equal to the size of the widget group among at least one size supported by the widget.

According to an embodiment, if it is identified that the widget displayed on the display (e.g., the display 260 in FIG. 2) is a first widget whose size is changeable, the electronic device may identify whether there is a size smaller than or equal to a first size corresponding to the size of the widget group among a plurality of sizes supported by the first widget.

According to an embodiment, if it is identified that the widget displayed on the display is a second widget whose size is unchangeable, the electronic device may identify whether the current size of the second widget is smaller than or equal to the first size corresponding to the size of the widget group.

If there is a size that is smaller than or equal to the size of the widget group among at least one size supported by the widget in operation 2203, the electronic device may change the size of the widget to the size smaller than or equal to the size of the widget group, and may then move the widget to the widget group and display it to overlap the widget group in operation 2205.

According to an embodiment, in the case where it is identified that the widget displayed on the display (e.g., the display 260 in FIG. 2) is a first widget whose size is changeable, if there is a size that is smaller than or equal to the first size corresponding to the size of the widget group among the plurality of sizes supported by the first widget, the electronic device may change the size of the first widget to the size smaller than or equal to the first size corresponding to the size of the widget group, and may then move the widget to the widget group and display it to overlap the widget group.

According to an embodiment, in the case where it is identified that the widget displayed on the display is a first widget whose size is changeable, if the current size of the first widget is identified as a size smaller than or equal to the first size corresponding to the size of the widget group, the electronic device may move the first widget to the widget group without changing the size of the first widget and display it to overlap the widget group.

According to an embodiment, in the case where it is identified that the widget displayed on the display is a second widget whose size is unchangeable, if the current size of the second widget is identified as a size smaller than or equal to the first size corresponding to the size of the widget group, the electronic device may move the second widget to the widget group and display it to overlap the widget group.

If there is no size smaller than or equal to the size of the widget group among at least one size supported by the widget in operation 2203, the electronic device may change the size of the widget group to a size supported by the widget size, and may then move the widget to the widget group and display it to overlap the widget group in operation 2207.

According to an embodiment, in the case where the widget displayed on a display (e.g., the display 260 in FIG. 2) is a first widget whose size is changeable, if it is identified that there is no size that is smaller than or equal to the first size of the widget group among the plurality of sizes supported by the first widget, the electronic device may identify a second size corresponding to the smallest size among the plurality of sizes supported by the first widget. The electronic device may change the size of the widget group from the first size to the second size and change the second widget to the second size. The electronic device may move the second widget, which has been changed to the second size, to the widget group and display it to overlap the widget group.

According to an embodiment, if the electronic device identifies that there is no size that is smaller than or equal to the first size of the widget group among the plurality of sizes supported by the first widget and identifies the second size corresponding to the smallest size among the plurality of sizes supported by the first widget, the electronic device may identify at least one size supported by each of at least one widget included in the widget group. If the at least one widget is changeable to the second size, based on the at least one size supported by the at least one widget, the electronic device may change the widget group including the at least one widget to the second size. If all or one of the at least one widget is unchangeable to the second size, based on the at least one size supported by the at least one widget, the electronic device may not perform an operation of moving the widget to the widget group and displaying it to overlap the same.

According to an embodiment, in the case where the widget displayed on the display is a second widget whose size is unchangeable, if it is identified that there is no size of the second widget smaller than or equal to the first size of the widget group, the electronic device may change the size of the widget group from the first size to the size of the second widget, and may then move the second widget to the widget group and display it to overlap the widget group.

According to an embodiment, if it is identified that the size of the second widget is not smaller than or equal to the first size of the widget group, the electronic device may identify at least one size supported by each of at least one widget included in the widget group. If the at least one widget is changeable to the size of the second widget, based on the at least one size supported by the at least one widget, the electronic device may change the widget group including the at least one widget to the size of the second widget. If all or one of the at least one widget is unchangeable to the size of the second widget, based on the at least one size supported by the at least one widget, the electronic device may not perform an operation of moving the widget to the widget group and displaying it to overlap the same.

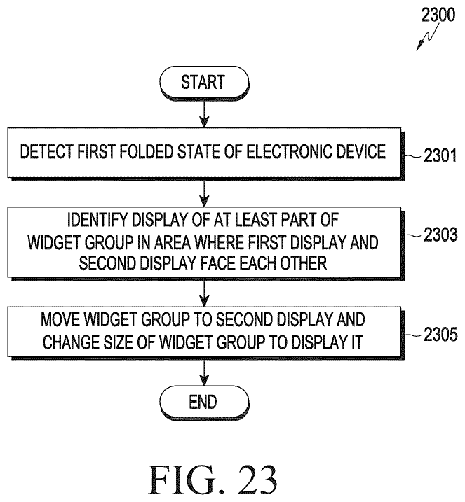

FIG. 23 is a flowchart illustrating an operation of controlling a widget group according to a folded state of an electronic device in an electronic device according to an embodiment of the disclosure. The operations of controlling the widget group may include operations 2301 to 2305. According to an embodiment, at least one of operations 2301 to 2305 may be omitted, the order of some operations may vary, or other operations may be added thereto.

Referring to FIG. 23, flowchart 2300 illustrates that, in operation 2301, an electronic device (e.g., the electronic device 101 in FIG. 1, the electronic device 201 in FIG. 2, and/or the electronic devices 301a to 301d in FIG. 3) may detect a first folded state of the electronic device.

According to an embodiment, the electronic device may detect a first folded state (e.g., half-folded state) of the electronic device in which the electronic device is folded at a predetermined angle (e.g., 80 degrees to 130 degrees) from an unfolded state, based on a signal received from a sensor module (e.g., the sensor module 276 in FIG. 2).

In operation 2303, the electronic device (e.g., the electronic device 101 in FIG. 1, the electronic device 201 in FIG. 2, and/or the electronic devices 301a to 301d in FIG. 3) may identify the display of at least a part of the widget group in an area where a first display (e.g., the first display 261 in FIG. 2) and a second display (e.g., the second display 263 in FIG. 2) face each other.

In operation 2305, the electronic device (e.g., the electronic device 101 in FIG. 1, the electronic device 201 in FIG. 2, and/or the electronic devices 301a to 301d in FIG. 3) may move the widget group to the second display and change the size of the widget group to display it.

According to an embodiment, in the case where the first display (e.g., the first display 261 in FIG. 2) is used as a display unit and the second display (e.g., the second display 263 in FIG. 2) is used as an input unit in the first folded state (e.g., half-folded state) of the electronic device, the electronic device may move the widget group to the second display and display it.

According to an embodiment, when moving the widget group to the second display used as an input unit in the first folded state (e.g., half-folded state) of the electronic device, the electronic device may determine a plurality of areas having a plurality of coordinates at which the widget group is to be displayed as starting coordinates on the second display, and may move and display the widget group to and on a first area having a first coordinate, as a starting coordinate, that is positioned closest to the starting coordinate of the area where the widget group is positioned, among the plurality of areas. If there is an existing icon or widget in the first area, the electronic device may move and display the widget group to and on a second area having a second coordinate, as a starting coordinate, that is the next closest after the first area to the starting coordinate of the area where the widget group is positioned, among the plurality of areas.

According to an embodiment, when moving the widget group to the second display used as an input unit in the first folded state (e.g., half-folded state) of the electronic device, if there is no space to display the widget group on the second display due to the existing multiple icons or widgets thereon, the electronic device may move at least one icon or widget, based on a priority, among the multiple icons or widgets displayed on the second display, to the first display, and then move and display the widget group to and on the second display.

According to an embodiment, when moving the widget group to the second display used as an input unit in the first folded state (e.g., half-folded state) of the electronic device, the electronic device may change the size of the widget group and display it.

According to an embodiment, when moving the widget group to the second display used as an input unit in the first folded state (e.g., half-folded state) of the electronic device, the electronic device may change the size of a grid configuring a home screen of the second display and display the widget group maintaining its size on the home screen of the second display of which the grid was changed.

According to an embodiment, when moving the widget group to the second display used as an input unit in the first folded state (e.g., half-folded state) of the electronic device, if the widget group includes a second widget whose size is unchangeable, the electronic device may reduce only the scale of the second widget while maintaining the ratio of the second widget and display it.

According to an embodiment, the electronic device, based on a third gesture (e.g., left and right swipe) detected on the widget group that was moved and displayed on the second display in the first folded state (e.g., half-folded state) of the electronic device, may sequentially display a plurality of widgets included in the widget group.

According to an embodiment, the electronic device, based on a third gesture (e.g., left and right swipe) detected on the widget group that was moved and displayed on the second display, may sequentially display a plurality of widgets included in the widget group by allowing looping in one direction (e.g., rightward direction).

According to an embodiment, a method for grouping a plurality of widgets in an electronic device may include identifying, when identifying of a widget displayed on a display of the electronic device to a widget group, whether there is a size smaller than or equal to a first size corresponding to a size of the widget group among at least one size supported by the widget.

According to an embodiment, the method may include, if there is a size smaller than or equal to the first size of the widget group among the at least one size supported by the widget, changing the widget to the size smaller than or equal to the first size of the widget group, and moving the resized widget to the widget group and displaying it to overlap the widget group.

According to an embodiment, the method may include, if a widget displayed on the display is a first widget whose size is changeable, and if the size of the first widget is not the same as the first size of the widget group, identifying whether there is a size smaller than or equal to the first size of the widget group among a plurality of sizes supported by the first widget.

According to an embodiment, the method may include, if there is a size smaller than or equal to the first size of the widget group among the plurality of sizes supported by the first widget, changing the first widget to the size smaller than or equal to the first size of the widget group.

According to an embodiment, the method may include moving the resized first widget to the widget group and displaying it to overlap the widget group.

According to an embodiment, the method may include, if a current size of the first widget displayed on the display is the same as the first size of the widget group, moving the first widget to the widget group without changing the size of the first widget and displaying it to overlap the widget group.

According to an embodiment, the method may include, if the widget displayed on the display is a second widget whose size is unchangeable, and if the size of the second widget is the same as the first size of the widget group, moving the widget to the widget group and displaying it to overlap the widget group.

According to an embodiment, the method may include, if the widget displayed on the display is a first widget whose size is changeable, and if it is identified that there is no size smaller than or equal to the first size of the widget group among the plurality of sizes supported by the first widget, identifying a second size corresponding to a smallest size among the plurality of sizes supported by the first widget.

According to an embodiment, the method may include changing the size of the widget group from the first size to the second size.

According to an embodiment, the method may include changing the second widget to the second size.

According to an embodiment, the method may include moving the second widget changed to the second size to the widget group and displaying it to overlap the widget group.

According to an embodiment, the method may include identifying at least one size supported by each of at least one widget included in the widget group.

According to an embodiment, the method may include identifying whether the at least one widget is changeable to the second size, based on the at least one size supported by each of the at least one widget.

According to an embodiment, the method may include, if the at least one widget is changeable to the second size, changing the widget group including the at least one widget to the second size.

According to an embodiment, the method may include, if the widget displayed on the display is a second widget whose size is unchangeable, and if the size of the second widget is not smaller than or equal to the first size of the widget group, changing the size of the widget group from the first size to the size of the second widget.

According to an embodiment, the method may include moving the second widget to the widget group and displaying it to overlap the widget group.

According to an embodiment, the method may include identifying at least one size supported by each of at least one widget included in the widget group.

According to an embodiment, the method may include identifying whether the at least one widget is changeable to the size of the second widget, based on the at least one size supported by each of the at least one widget.

According to an embodiment, the method may include, if the at least one widget is changeable to the size of the second widget, changing the widget group including the at least one widget to the size of the second widget.

According to an embodiment, the method may include, if display of at least a part of the widget group is identified in an area where a first display and a second display included in the display face each other when detecting a first folded state of the electronic device in which the electronic device is folded at a predetermined angle, moving and displaying the widget group to and on the first display or the second display.

According to an embodiment, the method may include changing the size of the widget group and displaying it, based on the number or sizes of icons disposed on the first display or the second display included in the display, when moving the widget group to one of the first display and the second display.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. The term “non-transitory” simply denotes that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment of the disclosure, there is provided a nonvolatile storage medium storing instructions, wherein the instructions are configured to cause, when executed by the electronic device, the electronic device to perform at least one operation, and wherein the at least one operation may include identifying, when identifying movement of a widget displayed on a display of the electronic device to a widget group, whether there is a size smaller than or equal to a first size corresponding to the size of the widget group among at least one size supported by the widget, and if there is a size smaller than or equal to the first size of the widget group among the at least one size supported by the widget, changing the widget to the size smaller than or equal to the first size of the widget group, and moving the resized widget to the widget group and displaying it to overlap the widget group.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
at least one processor; and
memory storing instructions that, when executed by the at least one processor individually or collectively, cause the electronic device to:
when identifying movement of a widget displayed on the display to a widget group, identify whether there is a size smaller than or equal to a first size corresponding to a size of the widget group among at least one size supported by the widget, and
in case that there is a size smaller than or equal to the first size of the widget group among the at least one size supported by the widget, change the widget to the size smaller than or equal to the first size of the widget group, move the resized widget to the widget group, and display the resized widget to overlap the widget group.

2. The electronic device of claim 1, wherein the instructions, when executed by the at least one processor individually or collectively, cause the electronic device to:
in case that the widget displayed on the display is a first widget whose size is changeable, and in case that a size of the first widget is not a same size as the first size of the widget group, identify whether there is a size smaller than or equal to the first size of the widget group among a plurality of sizes supported by the first widget, and
in case that there is the size smaller than or equal to the first size of the widget group among the plurality of sizes supported by the first widget, change the first widget to the size smaller than or equal to the first size of the widget group, move the resized first widget to the widget group, and display the resized first widget to overlap the widget group.

3. The electronic device of claim 2, wherein the instructions, when executed by the at least one processor individually or collectively, cause the electronic device to:
in case that a current size of the first widget displayed on the display is the same size as the first size of the widget group, move the first widget to the widget group without changing the size of the first widget and display the first widget to overlap the widget group.

4. The electronic device of claim 1, wherein the instructions, when executed by the at least one processor individually or collectively, cause the electronic device to:
in case that the widget displayed on the display is a second widget whose size is unchangeable, and in case that the size of the second widget is a same size as the first size of the widget group, move the widget to the widget group and display the widget to overlap the widget group.

5. The electronic device of claim 1, wherein the instructions, when executed by the at least one processor individually or collectively, cause the electronic device to:
in case that the widget displayed on the display is the first widget whose size is changeable, and in case that it is identified that there is no size smaller than or equal to the first size of the widget group among the plurality of sizes supported by the first widget, identify a second size corresponding to a smallest size among the plurality of sizes supported by the first widget,
change the size of the widget group from the first size to the second size,
change the second widget to the second size,
move the second widget changed to the second size to the widget group, and
display the second widget changed to the second size to overlap the widget group.

6. The electronic device of claim 5, wherein the instructions, when executed by the at least one processor individually or collectively, cause the electronic device to:
identify at least one size supported by each of at least one widget included in the widget group,
identify whether the at least one widget is changeable to the second size based on the at least one size supported by each of the at least one widget, and
in case that the at least one widget is changeable to the second size, change the widget group comprising the at least one widget to the second size.

7. The electronic device of claim 1, wherein the instructions, when executed by the at least one processor individually or collectively, cause the electronic device to:
in case that the widget displayed on the display is a second widget whose size is unchangeable, and in case that a size of the second widget is not smaller than or equal to the first size of the widget group, change the size of the widget group from the first size to the size of the second widget,
move the second widget to the widget group, and
display the second widget to overlap the widget group.

8. The electronic device of claim 7,
wherein the instructions, when executed by the at least one processor individually or collectively, cause the electronic device to:
identify at least one size supported by each of at least one widget included in the widget group,
identify whether the at least one widget is changeable to the size of the second widget based on the at least one size supported by each of the at least one widget, and
in case that the at least one widget is changeable to the size of the second widget, change the widget group comprising the at least one widget to the size of the second widget.

9. The electronic device of claim 1, wherein the instructions, when executed by the at least one processor individually or collectively, cause the electronic device to:
in case that displaying of at least a part of the widget group is identified in an area, where a first display and a second display included in the display face each other when detecting a first folded state of the electronic device in which the electronic device is folded at a predetermined angle, move and display the widget group to and on the first display or the second display.

10. The electronic device of claim 9,
wherein the instructions, when executed by the at least one processor individually or collectively, cause the electronic device to:
change the size of the widget group and display the widget group having the changed size based on a number or sizes of icons disposed on the first display or the second display included in the display, when moving the widget group to one of the first display or the second display.

11. A method performed by an electronic device for grouping a plurality of widgets, the method comprising:
based on identifying movement of a widget displayed on a display of the electronic device to a widget group, identifying, by the electronic device, whether there is a size smaller than or equal to a first size corresponding to a size of the widget group among at least one size supported by the widget; and
based on identifying that there is the size smaller than or equal to the first size of the widget group among the at least one size supported by the widget, changing, by the electronic device, the widget to the size smaller than or equal to the first size of the widget group, moving, by the electronic device, the resized widget to the widget group, and displaying, by the electronic device, the resized widget to overlap the widget group.

12. The method of claim 11, further comprising:
based on the widget displayed on the display being a first widget whose size is changeable, and a size of the first widget is not a same size as the first size of the widget group, identifying, by the electronic device, whether there is a size smaller than or equal to the first size of the widget group among a plurality of sizes supported by the first widget;
based on identifying that there is the size smaller than or equal to the first size of the widget group among the plurality of sizes supported by the first widget, changing, by the electronic device, the first widget to the size smaller than or equal to the first size of the widget group; and
moving, by the electronic device, the resized first widget to the widget group and displaying, by the electronic device, the resized first widget to overlap the widget group.

13. The method of claim 12, further comprising:
based on a current size of the first widget displayed on the display being the same size as the first size of the widget group, moving, by the electronic device, the first widget to the widget group without changing the size of the first widget and displaying, by the electronic device, the first widget to overlap the widget group.

14. The method of claim 11, further comprising:
based on the widget displayed on the display being a second widget whose size is unchangeable, and a size of the second widget is a same size as the first size of the widget group, moving, by the electronic device, the widget to the widget group and displaying, by the electronic device, the widget to overlap the widget group.

15. The method of claim 11, further comprising:
based on the widget displayed on the display being the first widget whose size is changeable, and identifying that there is no size smaller than or equal to the first size of the widget group among the plurality of sizes supported by the first widget, identifying, by the electronic device, a second size corresponding to a smallest size among the plurality of sizes supported by the first widget;
changing, by the electronic device, the size of the widget group from the first size to the second size;
changing, by the electronic device, the second widget to the second size; and
moving, by the electronic device, the second widget changed to the second size to the widget group and displaying, by the electronic device, the second widget changed to the second size to overlap the widget group.

16. The method of claim 15, further comprising:
identifying, by the electronic device, at least one size supported by each of at least one widget included in the widget group;
identifying, by the electronic device, whether the at least one widget is changeable to the second size based on the at least one size supported by each of the at least one widget; and
based on identifying that the at least one widget is changeable to the second size, changing, by the electronic device, the widget group comprising the at least one widget to the second size.

17. The method of claim 11, further comprising:
based on the widget displayed on the display being a second widget whose size is unchangeable, and a size of the second widget is not smaller than or equal to the first size of the widget group, changing, by the electronic device, the size of the widget group from the first size to the size of the second widget;
moving, by the electronic device, the second widget to the widget group; and
displaying, by the electronic device, the second widget to overlap the widget group.

18. The method of claim 17, further comprising:
identifying, by the electronic device, at least one size supported by each of at least one widget included in the widget group;
identifying, by the electronic device, whether the at least one widget is changeable to the size of the second widget based on the at least one size supported by each of the at least one widget; and
based on identifying that the at least one widget is changeable to the size of the second widget, changing, by the electronic device, the widget group comprising the at least one widget to the size of the second widget.

19. The method of claim 11, further comprising:
based on displaying of at least a part of the widget group being identified in an area, where a first display and a second display included in the display face each other when detecting a first folded state of the electronic device in which the electronic device is folded at a predetermined angle, moving, by the electronic device, and displaying, by the electronic device, the widget group to and on the first display or the second display.

20. The method of claim 19, further comprising:
changing, by the electronic device, the size of the widget group and displaying, by the electronic device, the widget group having the changed size based on a number or sizes of icons disposed on the first display or the second display included in the display, in response to moving the widget group to one of the first display or the second display.
